(19) United States
(12) Patent Application Publication
(10) Pub. No.: US 2022/0363865 A1
(43) Pub. Date: Nov. 17, 2022

(54) LIGHTWEIGHT LIQUID METAL EMBEDDED ELASTOMER COMPOSITE

(71) Applicant: BOARD OF REGENTS OF THE UNIVERSITY OF NEBRASKA, Lincoln, NE (US)

(72) Inventors: Eric Markvicka, Lincoln, NE (US); Ethan Krings, Lincoln, NE (US)

(21) Appl. No.: 17/681,541

(22) Filed: Feb. 25, 2022

Related U.S. Application Data
(60) Provisional application No. 63/153,850, filed on Feb. 25, 2021.

(51) Int. Cl. C08K 3/08; C08G 77/04; C08K 7/26; C09D 11/023; C09D 11/037; C09D 11/102; B33Y 70/10; B33Y 40/10; B29C 64/314

(52) U.S. Cl. CPC C08K 3/08; C08G 77/04; C08K 7/26; C09D 11/023; C09D 11/037; C09D 11/102; B33Y 70/10; B33Y 40/10; B29C 64/314; B29K 2083/00

(57) ABSTRACT

A lightweight liquid metal composition and a method for producing a lightweight liquid metal composition. The composition includes: a liquid metal inclusion; a low-density phase including a plurality of particles; and an elastic polymer. The method includes: combining a low-density phase with a liquid metal to produce a multiphase liquid metal (LM), the low-density phase including a material having a density less than a density of the LM; mixing the multiphase LM with an elastomer to produce an emulsion; and curing the emulsion to produce a lightweight LM composition.

### CROSS-REFERENCE TO RELATED APPLICATIONS

The present application claims priority to U.S. Provisional Patent Application No. 63/153,850 that was filed Feb. 25, 2021, the entire contents of which are hereby incorporated by reference.

### STATEMENT REGARDING FEDERALLY SPONSORED RESEARCH

This invention was made with government support under 80NSSC19M0065 and NNX15A109H and 80NSSC20M0112 awarded by the National Aeronautics and Space Administration. The government has certain rights in the invention.

### BACKGROUND

Soft, elastically deformable materials with high thermal conductivity are critical for numerous industries including healthcare, aerospace, automotive, and flexible electronics, where combinations of high mechanical compliance and high thermal conductivity are required. An emerging material architecture are elastomer composites that have a liquid-metal (LM) microdroplets embedded in hyperelastic polymers. These all soft-matter systems exhibit exceptional thermal properties, are electrical insulating even at high volume loadings, and remain soft and stretchable even at extremely low temperatures (−80° C.). Although these materials exhibit a unique combination of properties, the high density and high volume loading of the LM filler significantly increases the density of the composite, which can be problematic for large-area thermal management and weight sensitive applications such as wearable electronics, aerospace thermal control, and clothing.

### SUMMARY

In one aspect, a lightweight liquid metal composition including: a liquid metal inclusion; a low-density phase including a plurality of particles; and an elastic polymer.

In another aspect, a method for producing a lightweight liquid metal composition, including: combining a low-density phase with a liquid metal to produce a multiphase liquid metal (LM), the low-density phase including a material having a density less than a density of the LM; mixing the multiphase LM with an elastomer to produce an emulsion; and curing the emulsion to produce a lightweight LM composition.

### BRIEF DESCRIPTION OF THE FIGURES

The patent or patent application file contains at least one drawing in color. Copies of this patent or patent application publication with color drawings will be provided by the Office upon request and payment of the necessary fee.

FIG. 1 shows a schematic of the fabrication of multiphase liquid metal (LM) and lightweight liquid metal elastomer (LMME) composite.

FIG. 2 shows construction and testing of a lightweight liquid metal elastomer (LLME) composite. Panel a) shows material schematic showing the dispersion of multiphase LM inclusions embedded in a soft, elastomer matrix. Panel b) shows a cutaway material schematic showing the dispersion of low-density, hollow glass microspheres dispersed in the LM. Panel c) shows normalized thermal conductivity and density as a function of low-density microsphere volume loading (n=3). Panel d) shows a LLME composite material design space with lines of constant density and thermal conductivity as a function of low-density glass microsphere and multiphase LM volume loading. (inset) Experimentally measured thermal conductivity and density of the selected compositions with marked symbols (n=3). Panels e) and f) show photographs of the selected compositions with marked symbols e) submerged in a heavy liquid, and panel f) shows the IR thermal response when a constant current is applied to an embedded resistive heating element. All error bars represent ±1 SD and are not displayed if smaller than the data point size.

FIG. 3 shows construction and testing of a lightweight multiphase liquid metal. Panel a) shows cross-sectional SEM image in back scattered electron (BSE) mode of the multiphase LM with φ=20%. Panel b) shows an overlay of Si and O element maps on the original SEM image to highlight the locations of the glass microspheres. Location of the element map is shown in panel (a). Panels c) and d) show corresponding SEM images in BSE and overlay with φ=50%. Panel e) shows viscosity of the multiphase LM versus shear rate with lines of different glass volume loadings (n=3). Panel f) shows density of the multiphase LM and (inset) LLME versus glass volume loading (n=3). The dashed line is the predicted density. Panel g) shows photographs of the multiphase LM transitioning from a liquid to thick paste with increasing volume fractions of glass microspheres from 0% to 50% by volume. All error bars represent ±1 SD and are not displayed if smaller than the data point size.

FIG. 4 shows mechanical and thermal characteristics of the LLME composite. Panel a) shows stress versus strain under tensile loading to failure for LLME composites with increasing glass microsphere volume loading for φ=50% (ψ=0%, 10%, 20%, 30%, 40%, 50%). (inset) Tensile modulus as a function of glass microsphere volume loading for φ=50%. Panel b) shows measured composite thermal conductivity as a function of glass microsphere volume loading for φ=50%. Dashed line is theoretical predictions of Bruggeman EMT model. (inset) Predicted thermal conductivity of the multiphase LM inclusion using the Bruggeman EMT model (Equation (1) with L=⅓) as a function of glass microsphere volume loading. Panel c) shows measured composite thermal conductivity versus strain, parallel (k_{y}) and perpendicular (kᵣ) to the direction of stretch for an unfilled elastomer (blue; φ=ψ=0%) and LLME composite (black; φ=36.5%, ψ=40%). The dashed lines represent the modified Bruggeman model with strain-dependent L. Panel d) shows normalized anisotropic thermal conductivity in the stress-free state after loading to 200% strain for each loading cycle (φ=36.5%, ψ=40%; n=3). All error bars represent ±1 SD and are not displayed if smaller than the data point size.

FIG. 5 shows quantitative design maps for thermal conductivity and density in soft composite materials. Panel a) shows a contour plot of composite thermal conductivity (k_{c}) as a function of filler thermal conductivity (kₚ) and filler volume loading (φ) based on the Bruggeman EMT model. Panel b) shows a contour plot of composite density (ρ_{c}) as a function of filler density (ρₚ) and filler volume loading (φ). Panels a) and c) show gray scale dashed lines indicate this work (φ=50% and ψ=0% to 50%). The other dashed lines indicate prior work: red) LM-diamond mixture, orange) LM-W mixture, and green) LM-Cu mixture. It is noted that the LM-Cu mixture form intermetallic species and solidify at low volume loadings. Panel c) shows a contour plot of LLME composite thermal conductivity normalized by the density (k_{c}/p_{c}) as a function of low-density volume loading (ψ) and multiphase LM volume loading (φ). Contour lines indicate lines of constant density (white) and constant thermal conductivity (black).

FIG. 6 shows a passive LLME heat spreader for emerging weight-sensitive and large-area applications. Panel a) shows an array of passive LLME heat spreaders embedded with Nichrome wires that act as resistive heaters. Samples (i), (ii), (iii) all have the same thermal conductivity (k_{c}=1 W m-1 K-1) but increase in density from left to right. The bottom samples are included for comparison. Panel b) shows material volume fraction (top) and thermal conductivity (bottom) versus composite density for the samples in panel (a). Panel c) shows IR snapshots of the passive heat spreaders at 2, 10, 20, and 30 min. A constant current of 5 amps was applied for 30 min to observe the transferring of heat from the resistive heating element through the LLME heat spreader. Panel d) shows mean (teal) and maximum (red) temperature versus density for each LLME heat spreader at 2, 10, 20, and 30 min. The error bars represent the temperature distribution across each LLME heat spreader within one standard deviation. Panel e) shows maximum temperature versus time for each LLME heat spreaders.

FIG. 7 shows a scanning electron microscopy (SEM) image in secondary electron (SE) mode of the surface of the multiphase liquid metal with ψ=50% by volume glass microsphere loading.

FIG. 8 shows optical micrographs of the LLME composite with φ=50%. The volume fraction of the glass microsphere loading can be increased from ψ=0% to 50% by volume.

FIG. 9 shows optical micrographs of the LLME composite with φ=ψ=50%. Panel a) shows the inclusion size without the addition of hexane and panel b) shows with the addition of hexane. The viscosity of the ExSil 100 silicone elastomer can be reduced by adding hexane to achieve an inclusion size to be tuned independent of material composition.

FIG. 10 shows a comparison of the properties of the LLME composite (φ=ψ=50%) with and without the addition of hexane. Panel a) shows thermal properties and panel b) shows mechanical properties of the LLME composite. As φ and ψ increase, an increase in glass microsphere separation can be observed, which adversely affects the thermal and mechanical properties of the LLME composite.

FIG. 11 shows optical micrographs of the LLME composite at different volume loadings φ and ψ. For emulsions with ψ>30%, the two-part PDMS elastomer was first thinned with hexane at a 10:1, 6:1, and 5:1 mass ratio for ψ=30%, 40%, and 50%, respectively. The thinned elastomer was then combined with the multiphase LM suspension.

FIG. 12 shows a cross-sectional SEM image of the multiphase LM with ψ=20% with overlay of gallium (Ga), indium (In), silicon (Si), and oxygen (O) x-ray maps.

FIG. 13 shows an SEM image illustrating the size distribution of the glass microspheres. The expected microsphere diameter is 9-13 μm.

FIG. 14 shows photographs of experimental set ups. Panel a) shows a photograph of the experimental set up to measure the thermal-mechanical coupling of the soft elastomer composite. Panel b) shows a photograph of the multi-axis transient hot wire (THW) probe.

FIG. 15 shows cyclic loading to increasing strains (50%, 100%, 150%, and 200%) plotted as tensile stress versus strain for different LLME compositions.

FIG. 16 shows optical micrographs of the LLME microstructure (φ=36.5%, ψ=40%) during stretching. The images show the change in microstructure from to 0 to 400% strain in 100% increments.

FIG. 17 shows optical micrographs of the LLME microstructure (φ=36.5%, ψ=40%) before testing and after cyclical loading of 200% strain. Optical micrographs are taken in a stress-free state, 0% strain. The optical micrographs are taken at a similar but different location of the sample.

FIG. 18 shows design maps for density and thermal conductivity as a function of LLME composition. Panel a) shows a contour plot of composite density (ρ_{c}) as a function of low-density loading (ψ) and LM inclusion loading (φ). Panel b) shows a contour plot of composite thermal conductivity (k_{c}) as a function of low-density loading (ψ) and LM inclusion loading (φ).

FIG. 19 shows IR snapshots of the passive heat spreaders. The green outlines show the region in each sample where the temperature was monitored.

FIG. 20 shows an example of a process for producing a lightweight liquid metal composition in accordance with some embodiments of the disclosed subject matter.

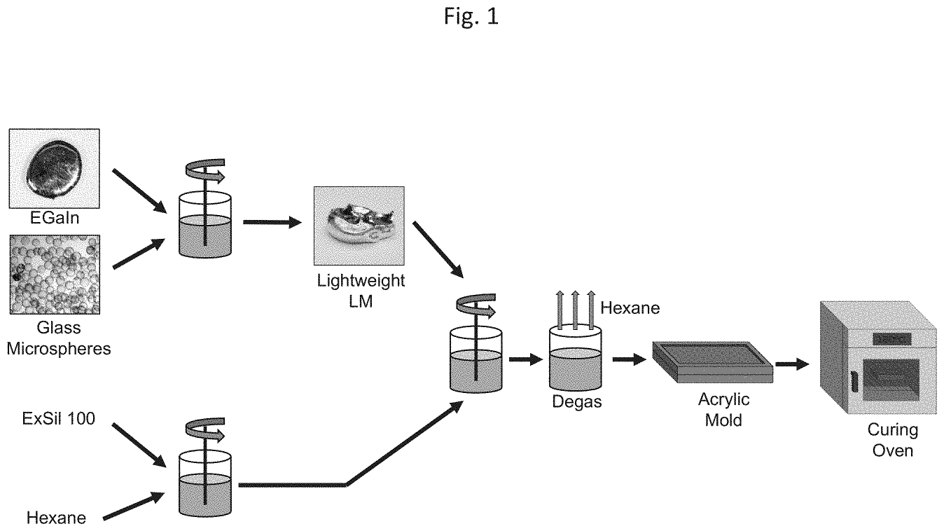

### DETAILED DESCRIPTION

Accordingly, disclosed herein are embodiments of a lightweight LM inclusion and methods for producing materials including a lightweight LM inclusion. Various embodiments of the compositions of matter disclosed herein have unique combinations of properties including high thermal conductivity, low mass density, and high deformability when embedded into an elastomer matrix. Furthermore, the composition of the lightweight, LM inclusion can be tailored, enabling a large range in density with negligible changes to the thermal conductivity of the inclusion as the thermal conductivity is dominated by electrons. Experimental thermal conductivity results measured using the transient hot-wire method agree well with the Bruggeman and Cheng-Vachon models of effective medium theory. As with previously reported LM embedded elastomer composites, this composite shows increased thermal conductivity under strain and can achieve maximum strain above 400%. This work presents a new material architecture to enable independent control of the thermal conductivity and density of LM elastomer composites, offering new opportunities to tune functional properties of systems where weight is critical. Various embodiments include methods for fabrication which can independently tune the thermal conductivity and density of soft materials.

Various embodiments provide a lightweight liquid metal composition and a method for producing a lightweight liquid metal composition. The composition can include a liquid metal inclusion, a low-density phase including a plurality of particles, and an elastic polymer. The method can include combining a low-density phase with a liquid metal to produce a multiphase liquid metal (LM), where the low-density phase can include a material having a density less than a density of the LM, mixing the multiphase LM with an elastomer to produce an emulsion, and curing the emulsion to produce a lightweight LM composition.

In some embodiments, the liquid metal inclusion has a melting point below 110° C., below 120° C., below 130° C., below 140° C., or below 150° C. In some embodiments the liquid metal inclusion could be a pure metal, an alloy, or a eutectic. In some embodiments the liquid metal could be gallium, eutectic gallium-indium, Galinstan, Field's metal, Rose's metal, Cerrosafe, Wood's metal, Cerrolow 136, Cerrolow 117, or Bi—Pb—Sn—Cd—In—Tl.

In various embodiments the low-density phase has a density equal to or less than 6.25 g cm⁻³, 6.44 g cm⁻³, 7.88 g cm⁻³, 8.2 g cm⁻³, 8.8 g cm⁻³, 9.4 g cm⁻³, or 9.7 g cm⁻³. In some embodiments the low-density phase could be a solid, a liquid, or a gas-filled void. In certain embodiments the low-density phase could include mesoporous silica particles or solid glass particles. In other embodiments the low-density phase could include carbon-based, including diamond particles, polystyrene particles, polypropylene particles. In other embodiments, the low-density phase could include metal particles, including magnesium.

In some embodiments the low-density phase could include a plurality of microspheres with a mean particle diameter of between 0.5-50 μm. More preferably, the mean diameter of the plurality of microspheres could be greater than 5 μm but less than 20 μm.

In various embodiments, the polydispersity index (PdI) of the plurality of microspheres can be calculated by:

$$PdI = {( \frac{σ}{mean particle diameter} )}^{2}$$

where α is the standard deviation of the particle diameter distribution. The standard deviation can be estimated by:

$$σ = \frac{Maximum of particle diameter range - minimum of particle diameter range}{4} .$$

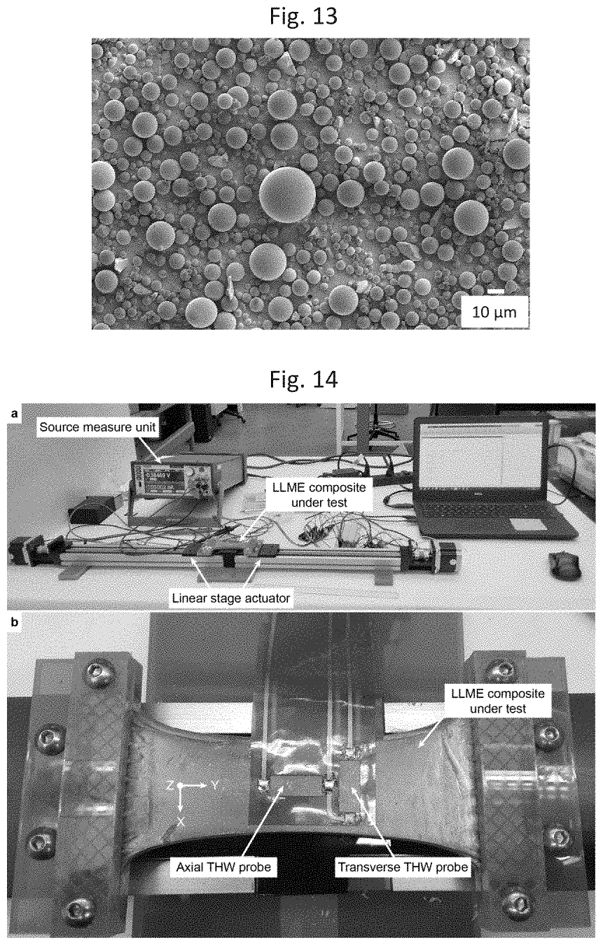

In some embodiments the polydispersity index of the plurality of microspheres is less than 0.1. In other embodiments, the polydispersity index is above 1. More preferably, the polydispersity index is at least 0.31 and no more than 0.65 in accordance with the range of particle diameters estimated in FIG. 13.

In some embodiments the elastic polymer can include a thermoset such as silicone-based polymer, a closed-cell foam, fluorosilicone, or a urethane, thermoplastic polymer including polyurethane, high consistency silicone rubber, UV curable polymer, or solution processable polymer including but not limited to styrene butadiene or styrene-isoprene-styrene (SIS) block copolymer.

In some embodiments the composite may experience a curing step to achieve its final form. In some embodiments curing may include a duration of time, exposure to ultraviolet light, exposure to temperatures above ambient temperature as in thermoplastics, or evaporation of a solvent, either assisted or unassisted by an externally applied vacuum, as in solution processable elastomers.

In various embodiments ellipsoidal particles that form as a result of mixing the elastomer with the multiphase liquid metal inclusion may be no smaller than 45 μm and no larger than 130 μm. In preferable embodiments, the ellipsoidal particles are no smaller than 90 μm and no larger than 110 μm. In some embodiments the aspect ratio of the ellipsoidal particles under 0% strain may be no less than 0.5 and no more than 1.7. More preferably, the aspect ratio could be 1.2. In some embodiments, particles that form can be spherical and have an aspect ratio between 0.9 and 1.1, and in some embodiments the aspect ratio can be approximately 1.0.

The lightweight liquid metal elastomer composite may have independently controlled thermal conductivity and density by changing the proportions of the liquid metal, the low-density phase, and the elastomer in the composite. In one embodiment the composite could include greater than 0% and less than 100% by volume of the liquid metal inclusion and no less than 5% and no more than 75% by volume of the low-density phase. The remaining balance by volume could be the elastic polymer.

In some embodiments there is a layer between the low-density phase that promotes the affinity of the low-density phase to the liquid metal. In some embodiments this affinity-promoting layer could be a metal oxide layer occurring natively or by an engineered method. In some embodiments, the metal oxide layer could be gallium oxide bismuth oxide, lead oxide, indium oxide, cadmium oxide, thallium oxide, antimony oxide, or tin oxide. In other embodiments the affinity promoting layer could be a surfactant. In yet other embodiments the affinity promoting layer could be a surface functionalization on the low-density phase or on the liquid metal inclusions. In some embodiments this surface functionalization could be a bifunctional ligand phosphonic acid tail or head group that could covalently bind to metal oxides.

In various embodiments, the thermal conductivity and density of the lightweight liquid metal elastomer composite may be independently controlled by changing the final proportions of the liquid metal, the low-density phase, and the elastomer in the composite. In some embodiments the range of the low-density phase volume loading could be no lower than 5% and no higher than 60% and result in no less than 20% and no more than 45% decrease in density and no less than 9% and no more than 19% decrease in thermal conductivity. In other embodiments the thermal conductivity can be maintained no lower than 0.5 W m⁻¹ K⁻¹ and no higher than 1.5 W m⁻¹ K⁻¹ while the composite density may be decreased from 3.2 to 2.3 g cm⁻³. In other embodiments, the density can be no lower than 1.2 g cm⁻³ and no higher than 3.2 g cm⁻³ while the thermal conductivity increases from 0.5 to 0.9 m⁻¹ K⁻¹. In yet another embodiment the multiphase liquid metal composite volume loading is no lower than 40% and no higher than 60%, the low-density volume loading is range from no lower than 5% and no higher than 60%, the strain break decreases from no higher than 700% to no lower than 250% tensile strain, and the elastic modulus of the composite increases from no lower than 80 kPa to no higher than 200 kPa.

In some embodiments the elastic modulus of the composite no higher than 160 kPa, 150 kPa, 140 kPa, 130 kPa, 120 kPa, 110 kPa, 100 kPa, 50 kPa, 25 kPa, 10 kPa, or 5 kPa.

In some embodiments, the thermal conductivity of the composite can change under strain. In some embodiments the thermal conductivity increases from no lower than k_{y}=0.25 W m⁻¹ K⁻¹ to no higher than k_{y}=5.0 W m⁻¹ K⁻¹ at 400% strain.

In some embodiments the components of the composite can be combined under mechanically applied shear mixing forces. In some embodiments the shear forces are applied with a planetary mixer. In other embodiments the shear mixing forces are applied with a handheld immersion blender. In other embodiments the shear forces could be applied with an overhead mixer or by a magnetic stir bar and stir plate. In still other embodiments, LM droplets can be formed by sonication or by microfluidic techniques and subsequently introduced into the polymer (e.g. a polymer matrix or polymer solution). For example, LM droplets can be formed through sonication in a surfactant, the surfactant can then be removed, and the elastomer matrix would be cast around the remaining LM droplets. In some embodiments, the low density particles can be suspended within the liquid metal using sonication.

In some embodiments shear mixing can be performed in an oxygen-rich environment to promote the formation of an oxide layer on the surface of the plurality of low-density phase particles. In one preferable embodiment, this can include ambient oxygen conditions. Another embodiment could be an oxygen-enriched environment wherein the percent of oxygen is no lower than 21% and no higher than 100%. In other embodiments, an oxide layer can form in relatively low oxygen environments, e.g. <10 ppm, based on dissolved oxygen that is present in silicone and/or solvents. In certain embodiments, degassing of the composite can occur, e.g. as part of the shear centrifugal mixing process, such that air voids >1 μm in size are removed from the composite. A vacuum can also be pulled during the shear mixing process to remove air voids <1 μm in size (although this does not remove the dissolved oxygen from the elastomeric polymer). In still other embodiments, degassing can be performed in a desiccator after shear mixing.

In certain embodiments the emulsion of lightweight liquid metal elastomer composite can be cured. In one preferred embodiment it can be cured by heating. In some embodiments curing can be performed at no lower than 50° C. and no higher than 200° C. for no less than 1 hour and no more than 8 hours.

In some embodiments, a solvent can be used to reduce the viscosity of the elastomer. In one embodiment the solvent can be an alkane, preferably hexane. In other embodiments the solvent could be any solvent that is miscible in polydimethylsiloxane.

In some embodiments the solvent used to reduce the viscosity of the elastomer is removed prior to curing the emulsion. In one embodiment the solvent could be removed by evaporation under ambient conditions for no less than 15 minutes and no more than 24 hours. In another preferred embodiment the solvent could be removed by evaporation under vacuum conditions for no less than 15 minutes and no more than 5 hours.

Lightweight and elastically deformable soft materials that are thermally conductive are critical for emerging applications in wearable computing, soft robotics, and thermoregulatory garments. To overcome the fundamental heat transport limitations in soft materials, room temperature liquid metal (LM) has been dispersed in elastomer that results in soft and deformable materials with unprecedented thermal conductivity. However, the high density of LMs (>6 g cm⁻³) and the typically high loading (>85 wt %) required to achieve the desired properties contribute to the high density of these elastomer composites, which can be problematic for large-area, weight-sensitive applications. Here, the relationship between the properties of the LM filler and elastomer composite is systematically studied. Experiments reveal that a multiphase LM inclusion with a low-density phase can achieve independent control of the density and thermal conductivity of the elastomer composite. Quantitative design maps of composite density and thermal conductivity are constructed to rationally guide the selection of filler properties and material composition. This new multiphase material architecture provides a method to fine-tune material composition to independently control material and functional properties of soft materials for large-area and weight-sensitive applications.

Elastomer composites with embedded droplets of gallium based liquid metal (LM) have demonstrated great potential as a soft, multifunctional composite that can be engineered to exhibit a wide range of functional properties. Eutectic gallium-based LM alloys such as EGaIn (eutectic gallium-indium) or Galinstan (eutectic gallium-indium-tin) are typically selected as the liquid filler due to the combination of high electrical and thermal conductivity, low viscosity, and nontoxic characteristics. By dispersing LM inclusions into elastomers, functional properties—including thermal conductivity, dielectric constant, and electrical conductivity—can be improved with negligible changes in stiffness and extensibility of the host elastomer, even at high loading. LM embedded composites exhibit a unique combination of functional properties, low stiffness, and high strain limit that overcomes fundamental limitations of soft and deformable materials and offers great promise for emerging applications in soft robotics and wearable computing that require highly functional and elastically deformable materials. Despite the improved properties, both the density of Ga-based LMs (EGaln: 6.25 g cm⁻³; Galinstan: 6.44 g cm⁻³) and typically high loading (≥85 wt %, or ≥50 vol %) required to achieve the desired functional properties contribute to the high density of LM embedded composites, which can be problematic for large area and weight-sensitive applications.

Recently, researchers have shown that the properties of Ga-based LMs can be enhanced through the addition of solid particles. Several LM mixtures have been studied to improve the thermo-mechanical properties, rheology and consistency, and density of LM. This has resulted in LM mixtures with high thermal conductivity >100 W m⁻¹ K⁻¹, a fourfold increase as compared to pure LM, LM pastes that can be easily spread on a surface, and LM mixtures that can float on water. However, LM mixtures that include metallic particles with fcc crystal structures, such as copper (Cu), silver (Ag), iron (Fe with fcc crystal structure), and nickel (Ni), tend to spontaneously react with LM and form intermetallics that solidify at low loading. For LM mixtures with particles that do not form intermetallic species, the rheology and consistency of the mixtures are controlled by the fraction of solid particles that are added to the mixture, resulting in a transition from a liquid to paste-like rheology (<50% by volume) or liquid to powder at higher volume loading (>50%). The viscosity of the mixture can also be increased through vigorous or extended mixing that results in excessive gallium oxide formation that can be mixed into the LM.

Hybrid mixtures of LM with solid particles can be dispersed in an elastomer matrix to create multiphase LM embedded composites. If intermetallic species form that solidify, the LM mixture can degrade the mechanical response of the composite. Alternatively, LM hybrid mixtures with particles such as tungsten or diamond that do not form intermetallic species and result in significant increases in thermal conductivity (two to four times) provide a possible alternative to enhance the functional properties of soft materials without degrading the mechanical response. However, the density of tungsten (kₚ=19.25 g cm⁻³) is significantly higher than pure LM (kₚ<6.5 g cm⁻³), which could be problematic for large-area and weight-sensitive applications, while diamond's high cost can be prohibitive. Considering these recent LM hybrid mixtures and interest in enhancing the properties of LM embedded elastomers, additional insight may be needed to understand how the LM filler properties such as thermal conductivity, viscosity, and density influence the thermal conductivity, stiffness, and density of LM embedded elastomer composites. This new understanding into the relationship between filler and composite properties can provide new tools for designing soft and elastically deformable materials with high thermal conductivity.

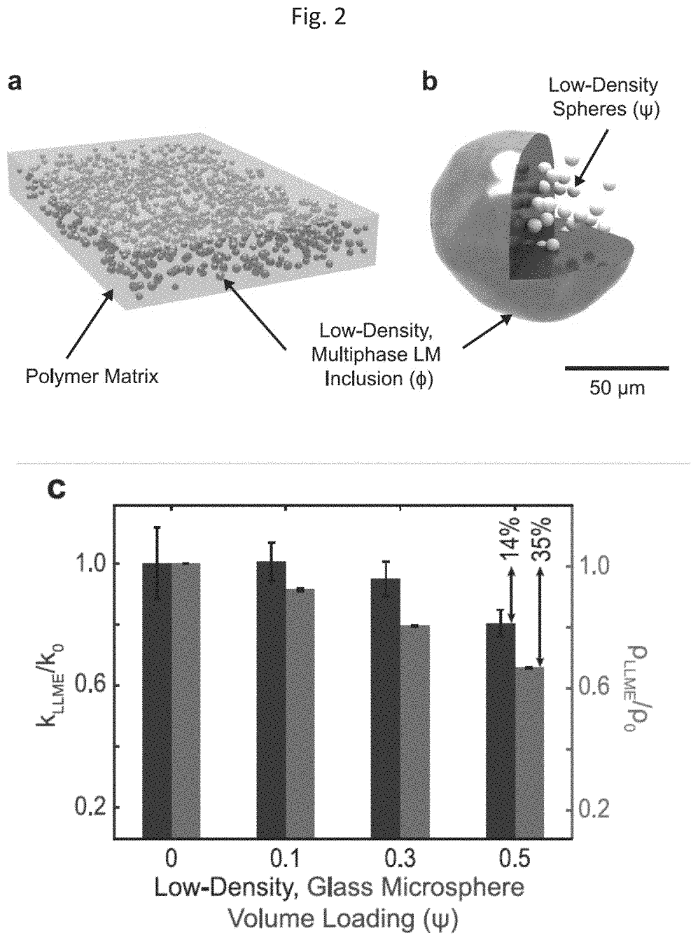

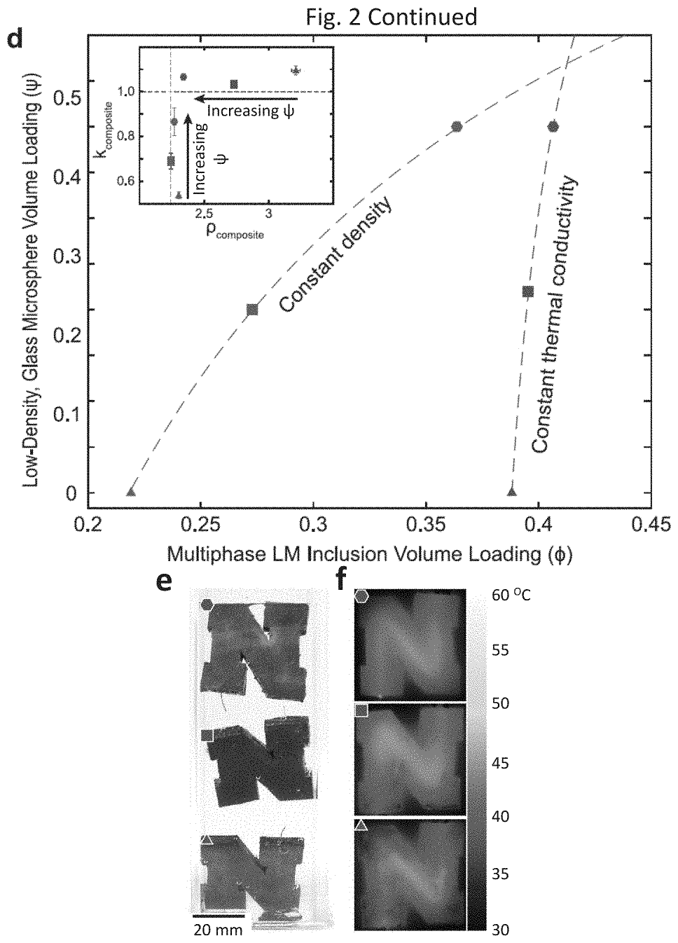

Here, we introduce a multiphase, soft-matter composite including a multiphase LM filler with a low-density phase that can be dispersed in a highly deformable silicone elastomer (FIG. 2). Through the addition of the low-density phase, we find that the thermal conductivity and density of the soft elastomer composite can be independently controlled by tailoring the volume loading of the low-density phase and LM multiphase inclusion. Specifically, as the volume loading of the low-density filler is increased, we observe a significant reduction in the density with only a modest decrease in the thermal conductivity of the composite. The thermal conductivity of the composite can be increased by increasing the volume loading of the multiphase filler. To further understand the relationship between filler and composite properties, a quantitative design map of thermal conductivity and density can be constructed as a function of filler properties and volume loading. These design maps can provide new insight for tailoring the composition to control the composite properties. To guide the rational selection of material composition and achieve the desired thermal conductivity and density of the LM elastomer composite, a quantitative design map can be constructed as a function of material composition. Using this design map, we identify lines of constant thermal conductivity and density to achieve independent control of the density and thermal conductivity. The ability to tailor material composition to control the density of the composite without influencing the thermal conductivity can be experimentally demonstrated. The thermal characteristics of the multiphase elastomer composite as a passive heat spreader was evaluated as a function of material composition. The incorporation of a low-density filler in multiphase LM elastomer composites provides new opportunities to independently control material and functional properties for large-area and weight-sensitive applications.

Lightweight Liquid Metal-Elastomer Composite. The lightweight LM-elastomer (LLME) composite that has of multiphase LM inclusions embedded in a soft silicone elastomer (ExSil 100, Gelest; FIG. 2a). The multiphase-LM inclusion can include hollow glass microspheres suspended within a Ga-based LM (FIG. 2b). The glass microspheres were chosen as the low-density phase due to their chemical and mechanical stability when mixed with Ga-based metals, relatively uniform diameter (9-13 μm), low cost, and low density (1.1 g cm⁻³) as compared to the density of EGaIn (6.25 g cm⁻³). The multiphase-LM can be fabricated by mechanically shear mixing a range of glass microsphere loadings from

$$ψ = 0 to 50 \% by volume , ( ψ = \frac{vol ( low density filler )}{vol ( low density filler + LM )} ) ,$$

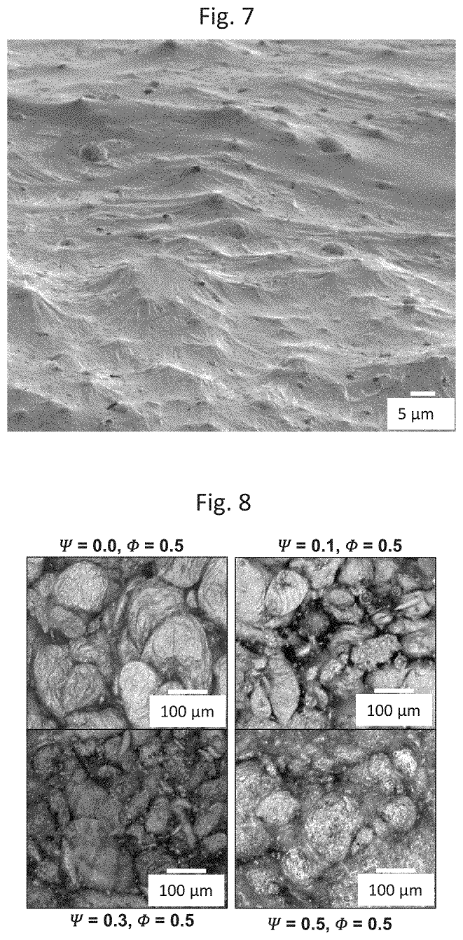

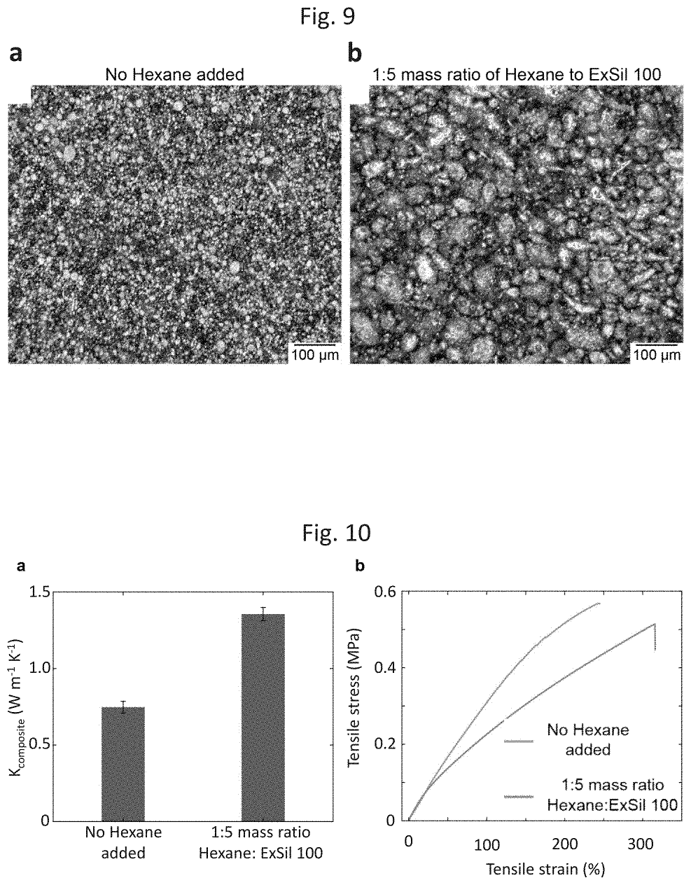

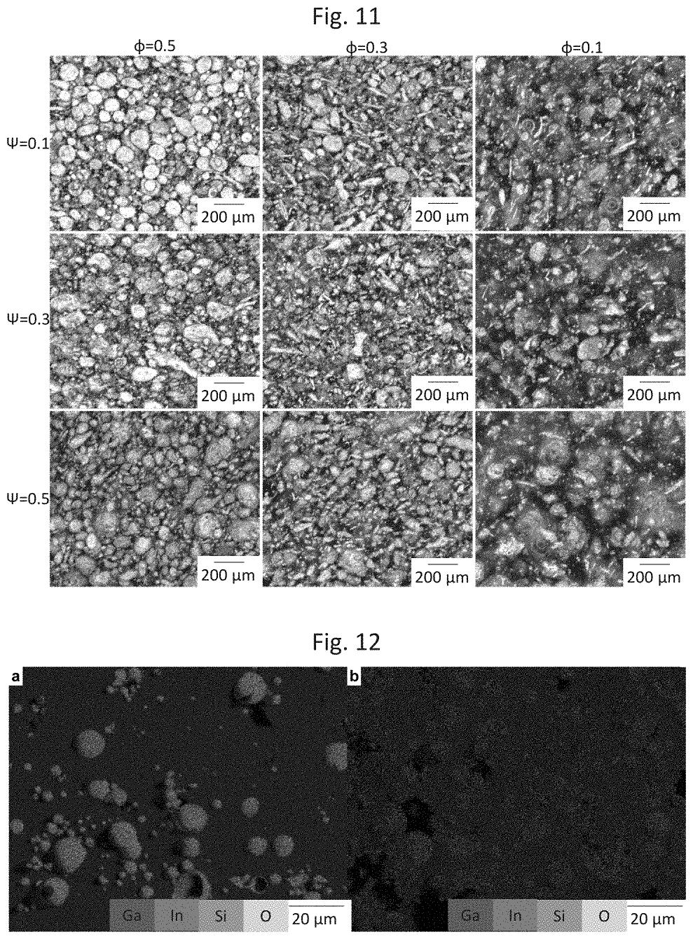

with LM in an oxygen-rich environment (e.g., ambient conditions), creating a colloidal suspension. As observed in the scanning electron microscopy (SEM) images of the surface of the multiphase LM, the majority of the glass microspheres are suspended in the LM with the outer surface includes a thin Ga oxide shell that can be formed when exposed to oxygen (ψ=50%, FIG. 7). During mixing in an oxygen-rich environment, the glass microspheres are coated with Ga oxide that promotes their affinity to the LM, becoming a so-called affinity-promoting layer. The LLME composite can be fabricated by mechanically shear mixing the multiphase LM with uncured elastomer, creating a dispersion of generally ellipsoidal particles ≈100 μm in diameter (FIG. 8). The resulting particle size can be a function of the mixture viscosity that depends on the LM loading and the multiphase LM viscosity, which can be a function of the glass microsphere loading. As expected, the average particle diameter decreased with increased volume loading of the glass microspheres (ψ). At high volume fractions of glass microspheres (ψ≥30%), relatively small multiphase LM inclusions were formed as compared to the glass microspheres during mixing. As the multiphase LM droplet size decreased and approached the mean diameter of the glass microspheres, we observed an increase in separation of the glass microspheres from the multiphase LM suspension (FIG. 9). To study the influence of the droplet size and subsequent increased separation of the glass microspheres from the multiphase LM suspension, hexane was first mixed with the uncured elastomer to reduce the mixture viscosity and achieve a larger droplet size (D≈100 μm). Hexane was chosen due to its miscibility in polydimethylsiloxane and its high vapor pressure, which allowed the hexane to be easily evaporated from the uncured composite after mechanical shear mixing. The mechanical and thermal properties of the LLME composite (φ=ψ=50%) with and without the use of hexane is shown in FIG. 10. We observe that the decrease in droplet size and subsequent increased separation of the glass microspheres from the multiphase LM suspension adversely affects the mechanical and thermal properties of the bulk composite and resulted in increased modulus, reduced maximum elongation, and reduced bulk thermal conductivity. To overcome this issue and systematically control droplet size and material composition (φ, ψ), mixing speeds and hexane volume were varied for highly concentrated emulsions (φ=50%) until the desired multiphase LM particle size D≈100 μm was achieved, resulting in negligible separation of glass microspheres from the multiphase LM suspension (see Examples for details and FIG. 9). The highly concentrated emulsion (φ=50%) could then be diluted to achieve the desired LM volume loading. The optical micrographs of different combinations of φ and ψ are shown in FIG. 11. The fabrication approach enables control of inclusion size independent of inclusion composition and loading, while reducing the separation of the glass microspheres from the LM suspension during mixing, which can have adverse effects on the mechanical and functional properties of the LLME composite.

To study the relationship between filler and composite properties, the volume loading of the glass microspheres (φ) in the multiphase LM inclusions was increased from 0% to 50%. Here, the density and thermal conductivity of the filler decreases with increased loading of the glass microspheres. The multiphase LM inclusion volume loading

$$( ϕ = \frac{vol ( multiphase LM )}{vol ( multiphase LM + elastomer )} )$$

was held constant at φ=50% for all samples, unless otherwise noted. The density of the LLME composite was measured gravimetrically using a density determination kit (80253384, Ohaus). We observe an decrease in the density of the LLME composite as the volume loading of the glass microspheres (ψ) in the multiphase LM can be increased from 0% to 50% by volume (FIG. 2c). The bulk thermal conductivity was then measured using the transient hot-wire (THW) method, where a platinum wire is placed between two pieces of the material. As current is applied, the wire acts as a resistive heat source and thermometer that measures the change in temperature (ΔT) as a function of time (t). The change in temperature is related to thermal conductivity (k) of the material through the cylindrical heat diffusion equation (see Examples for details). As the volume loading of the glass microspheres is increased from 0% to 50% by volume, we observe an decrease in the thermal conductivity of the composite (FIG. 2c). Here, we experimentally observe that a hybrid LM mixture with a low-density phase with negligible thermal conductivity (0.085 W m⁻¹ K⁻¹) results in a significant reduction in the density with only a modest decrease the thermal conductivity as compared to the composite with pure LM. Due to the nonlinear relationship, the material composition can be tailored to achieve independent control of the density and thermal conductivity (FIG. 2d, red and blue lines, respectively). Starting with the pure LM elastomer composite we show that through the addition of a low-density phase, we can rationally modify the material composition to decrease the composite density from 3.2 to 2.3 g cm⁻³, while maintaining a constant thermal conductivity of 1.0 W m⁻¹ K⁻¹ (FIG. 2d inset, blue line). Alternatively, the thermal conductivity can be increased from 0.5 to 0.9 W m⁻¹ K⁻¹, while maintaining a constant density of 2.2 g cm⁻³ by increasing the loading of the low density phase and multiphase LM filler (FIG. 2d inset, red line). The ability to control the density of the LLME composite, while maintaining a constant thermal conductivity was then visually demonstrated by placing the three samples corresponding to the blue symbols in FIG. 2d in a heavy liquid (FIG. 2e). As shown in FIG. 2f, the samples are observed to have a similar thermal response when utilized as a passive heat spreading element and a constant current is applied to an embedded resistive heating element (NiChrome wire). These results demonstrate the ability to tailor the material composition to achieve independent control of the density and thermal conductivity of the soft elastomer composite, which is enabled through the addition of a low-density filler phase in the LM inclusion.

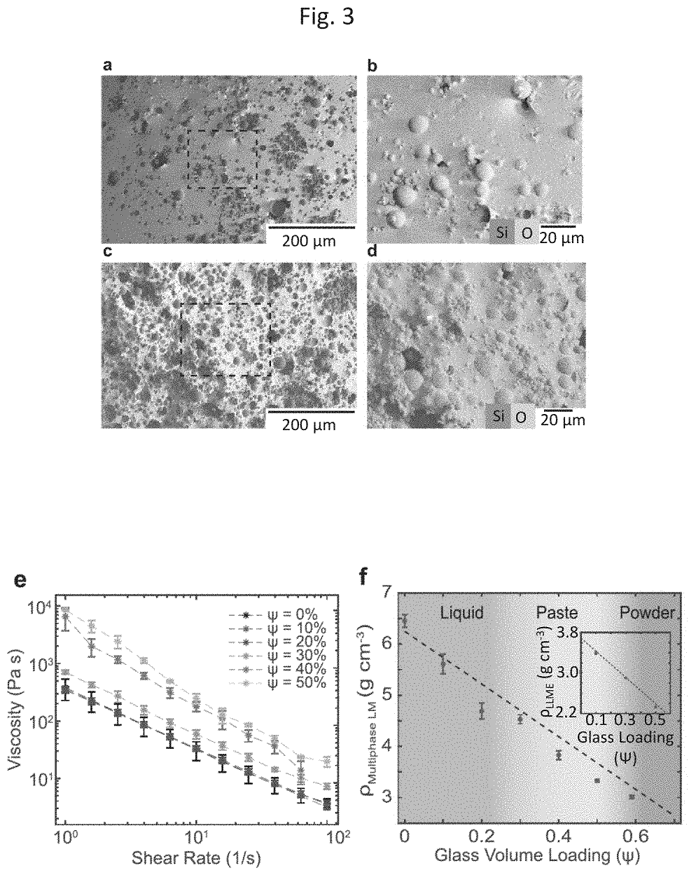

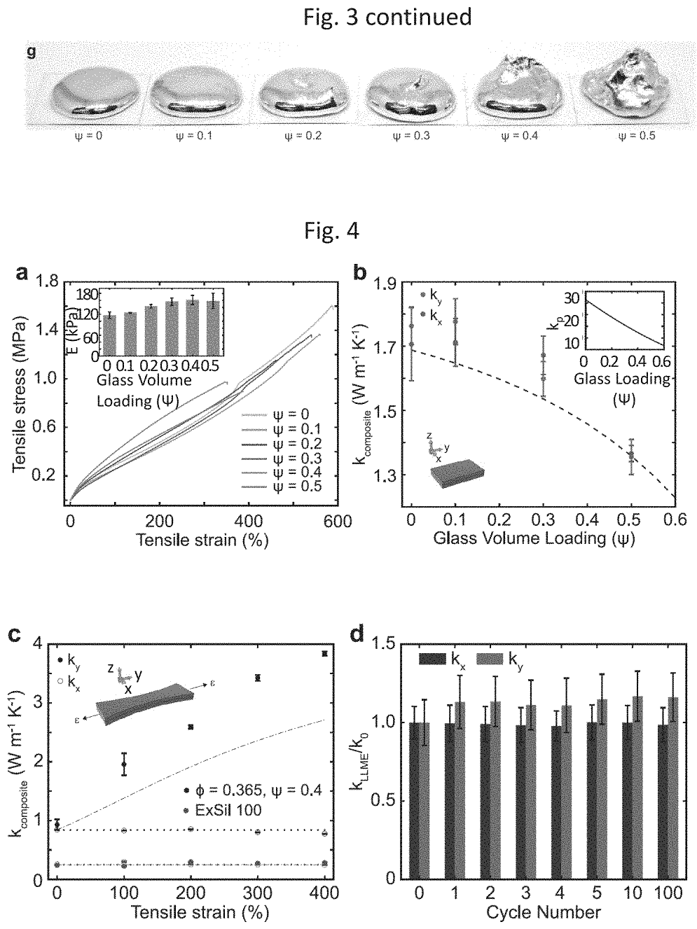

To determine the interaction and distribution of the glass microspheres in the LM, surface and cross-sectional SEM images were captured with energy dispersive X-ray spectroscopy (EDX) to analyze the location of elements. As observed in the SEM image of the surface of the multiphase LM with ψ=50%, the majority of the glass microspheres are suspended in the LM with the outer surface including a thin Ga oxide shell (FIG. 7). The cross-sectional SEM image of the multiphase LM with ψ=20% and ψ=50% are shown in FIG. 3a,c, respectively. The cross-section of the multiphase LM is created by freeze fracturing a capillary tube filled with the multiphase LM. We observe that the glass microspheres are well distributed throughout the LM with minimal aggregation. Furthermore, negligible pores are formed during mechanical shear mixing and are generally associated with glass microsphere aggregation. Elemental maps of silicon (Si) and oxygen (O) are overlaid on a portion of the original SEM image to better highlight the location of the glass microspheres (FIG. 3b,d). The presence of oxygen elements outside of the glass microsphere locations corresponds to the Ga oxide film that is spontaneously formed when the Ga-based LM is exposed to oxygen. Elemental maps of Ga, In, Si, and O can be found in FIG. 12.

The rheology and consistency of the multiphase LM is highly dependent on the volume loading of the glass microspheres. The viscosity of the LM suspension is presented in FIG. 3e. The pure LM and LM suspension exhibit a non-Newtonian, shear thinning behavior with increasing shear rate. The viscosity of the multiphase LM containing ψ<30% by volume has a similar viscosity to pure LM. As the volume loading is increased from ψ=30% to ψ=50%, the viscosity of the mixture increases and transitions from a liquid to thick paste that can be molded into different shapes (FIG. 3g). At higher volume loadings, ψ≥59%, the mixture transitions from a thick paste to powder. Here, LM mixtures with >50% that exhibited high viscosity and powder-like consistencies were not considered as they give rise to detrimental increases in rigidity of the final elastomer composite. Due to the large mismatch in density, phase separation of the LM and glass microspheres occurs (e.g., the glass microspheres float to the top of the LM). Before testing, the multiphase LM was stirred. The phase separation is not surprising and has been observed in other LM mixtures with large differences in density between the LM and filler.

The density of the multiphase LM mixture and LLME composite was measured gravimetrically using a density determination kit (FIG. 3f). The density of both the multiphase LM filler and LLME composite decreases as the volume loading of the glass microspheres is increased; where small differences are observed between the experimental data and the predicted density, ρ_{c}=ρₚ·φ+ρₘ(1−φ). Here, ρ_{c} is the density of the mixture or composite, ρₚ is the density of the discontinuous phase, φ is the volume loading of the discontinuous phase, and ρₘ is the density of the continuous phase. For the LLME composite, the volume loading of the multiphase LM filler was held constant at φ=50%. The measured density of the multiphase LM and LLME composite show reasonable agreement with the theoretical predictions, indicating that minimal air pockets are formed and trapped during the fabrication process as also observed in the cross-section SEM images (FIG. 3a,c). The difference between the experimental measurements and theoretical prediction could also be attributed to the glass microspheres that are observed to be outside of the expected 9-13 μm diameter range (FIG. 13).

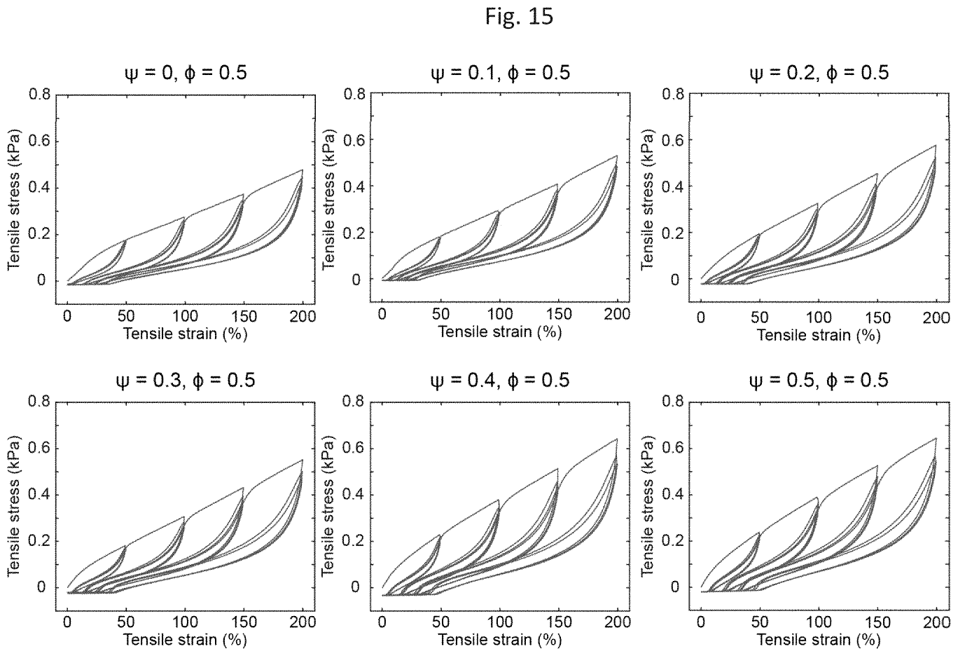

To study the influence of the filler viscosity on the mechanical response of the LLME composite, the volume loading of glass microspheres in the LM inclusions was increased from 0% to 50%, while the volume loading of the multiphase LM filler in the soft elastomer was held constant at φ=50%. The mechanical response under tension is shown in FIG. 4a. As the microsphere glass loading is increased, the strain at break decreases and elastic modulus increases (FIG. 4a inset). For all glass microsphere loadings, the LLME is shown to be soft with an elastic modulus less than 160 kPa and exhibit low hysteresis elasticity after the first loading cycle (FIG. 15). The modest increase in elastic modulus for the LLME composite can be attributed to the change in the viscosity of the multiphase LM that transitions from a liquid to thick paste as the loading of glass microspheres is increased from 0% to 50%. Separation of the glass microspheres from the multiphase LM can also cause the elastic modulus of the composite to increase.

To study the relationship between LM filler and LLME composite thermal conductivity, the volume loading of glass microspheres in the LM inclusions was increased from 0% to 50%, while the volume loading of the multiphase LM filler in the soft elastomer was held constant at φ=50%. The anisotropic thermal conductivity of the LLME composite was measured using two orthogonal THW probes (FIG. 14). These measurements can be decomposed into three orthotropic thermal conductivity values of the bulk material (kₓ, k_{y}, k_{z}). Here, we observe that the thermal conductivity generally decreases with increasing glass microsphere volume loading and the orthotropic thermal conductivity values are similar in all principal material directions (FIG. 4b). The similar orthotropic values indicate the multiphase LM inclusions are generally spherical and undergo negligible deformation during the fabrication process. The thermal conductivity of the unstrained LLME composite is predicted by the Bruggeman effective medium theory (EMT) model with a two-step approach as expressed in Equation (1).

$$( \frac{{k}_{p} - {k}_{c}}{{k}_{p} - {k}_{m}} ) {( \frac{{k}_{m}}{{k}_{c}} )}^{L} = 1 - ϕ \qquad ( 1 )$$

First, the thermal conductivity is predicted for the multiphase LM inclusion (k_{c}) with the glass microspheres as the discontinuous phase (kₚ=0.085 W m⁻¹ K⁻¹) and the LM as the continuous phase (kₘ=26.4 W m⁻¹ K⁻¹). Here, φ is the filler volume fraction of the discontinuous phase and L is the depolarization factor, evaluated as ⅓ for spherical particles, that can be modified to predict the thermal conductivity as a function of strain. The depolarization factor L can be modified to predict the effective thermal conductivity for an incompressible material under uniaxial extension (λ=l/l₀, where l₀ is the original length of the material and l is the current length of the material). Here, λ_{y}=λ and the directions orthogonal to the stretching direction are λₓ=λ_{z}, such that:

$${L}_{y} = ( \frac{1 - {e}_{p}^{2}}{2 {e}_{p}^{3}} ) ( ln ( \frac{1 + {e}_{p}}{1 - {e}_{p}} ) - 2 {e}_{p} ) \qquad ( 2 )$$

$${e}_{p} = \sqrt{1 - \frac{1}{{λ}^{3 / 2}}} \qquad ( 3 )$$

$${L}_{x} = {L}_{z} = \frac{1 - {L}_{y}}{2} \qquad ( 4 )$$

The predicted thermal conductivity of the multiphase LM inclusion is shown in the FIG. 4b inset. Next, the thermal conductivity of the LLME composite (k_{c}) is predicted using the calculated thermal conductivity of the multiphase LM filler as the discontinuous phase (kₚ) and the elastomer matrix as the continuous phase (kₘ=0.25 W m⁻¹ K⁻¹, measured experimentally see Examples for more details). The experimental data shows reasonable agreement with the theoretical predictions found using the Bruggeman EMT model (FIG. 4b). The relative change in thermal conductivity of the multiphase LM mixture (k_{p(ψ=50%)}/k_{p(ψ=0%)}≈36%) is significant as compared to the LLME composite (k_{c(ψ=50%)}/k_{c(ψ=0%)}≈80%).

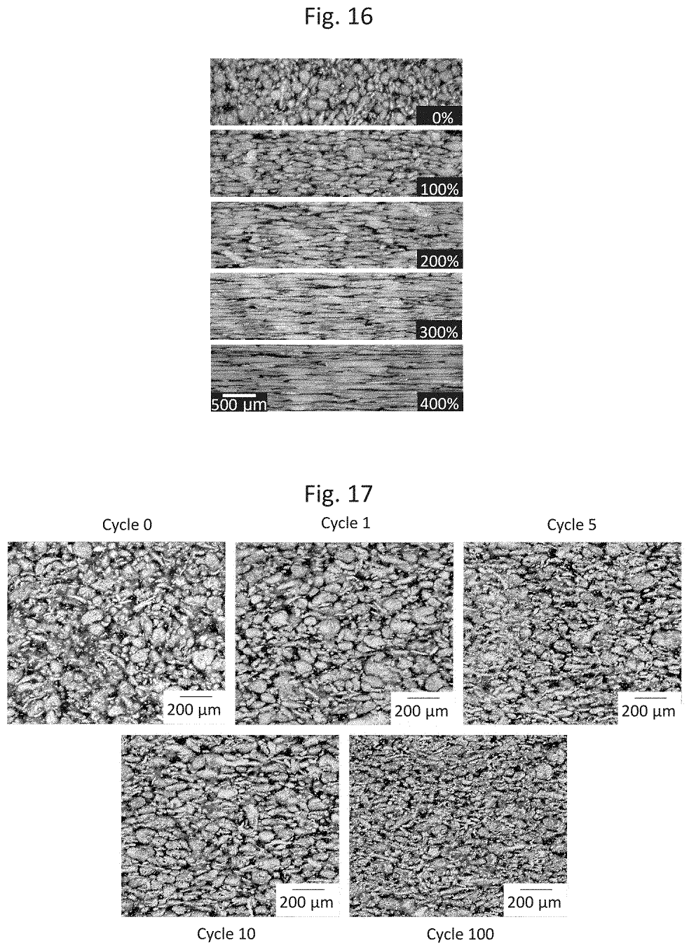

In contrast to rigid particle fillers, the shape of liquid phase fillers can be controlled through the application of strain to control the thermal conductivity. Here, we observe that the unfilled elastomer (φ=0%) has a constant thermal conductivity in the direction of strain (k_{y}=0.25 W m⁻¹ K⁻¹; FIG. 4c). When the LLME composite (φ=36.5%, ψ=40%) is stretched, the thermal conductivity in the direction of strain is increased to k_{y}=3.8 W m⁻¹ K⁻¹ at 400% strain (FIG. 4c). The thermal conductivity in the orthogonal direction (kₓ) slightly decreases as the composite is stretched, indicating the LLME composite remains electrically insulating and no droplet-droplet connections are formed during mechanical deformation. This enhancement in the direction of stretch can be attributed to the coupling between the liquid inclusion and elastomer matrix in which the deformable inclusions elongate into needle-like microstructures along the stretching direction to create enhanced thermally conductive pathways (FIG. 16). This phenomenon can be predicted using the modified Bruggeman approach by considering the change in aspect ratio of the liquid inclusions during deformation to predict strain induced thermal conductivity (see Examples for details). To predict the strain-induced thermal conductivity of the LLME composite, the depolarization factor (L) was only modified when predicting the thermal conductivity of the LLME composite as the aspect ratio of the rigid glass fillers remains unchanged under droplet deformation. The theoretical prediction captures the observed behavior, where k_{y} increases and kₓ slightly decreases upon stretching. In addition, the material is robust to cyclical loading with negligible changes in thermal conductivity after the first loading cycle when measured after 100 cycles of 200% strain (FIG. 4d). The increase in thermal conductivity of the composite initially increases in the direction of strain after the first loading cycle due to unrecoverable plastic strain that is induced. Optical micrographs of the liquid inclusion microstructure after cyclical loading are shown in FIG. 17.

Together, the mechanical and thermal responses show that the addition of a low-density phase with negligible thermal conductivity to the LM inclusions greatly reduces the density of the LLME composite without degrading the mechanical or thermal response. The ability to independently control the density and functional properties of soft elastomer composites is important for large-area and weight-sensitive applications such as wearable devices and aerospace thermal management.

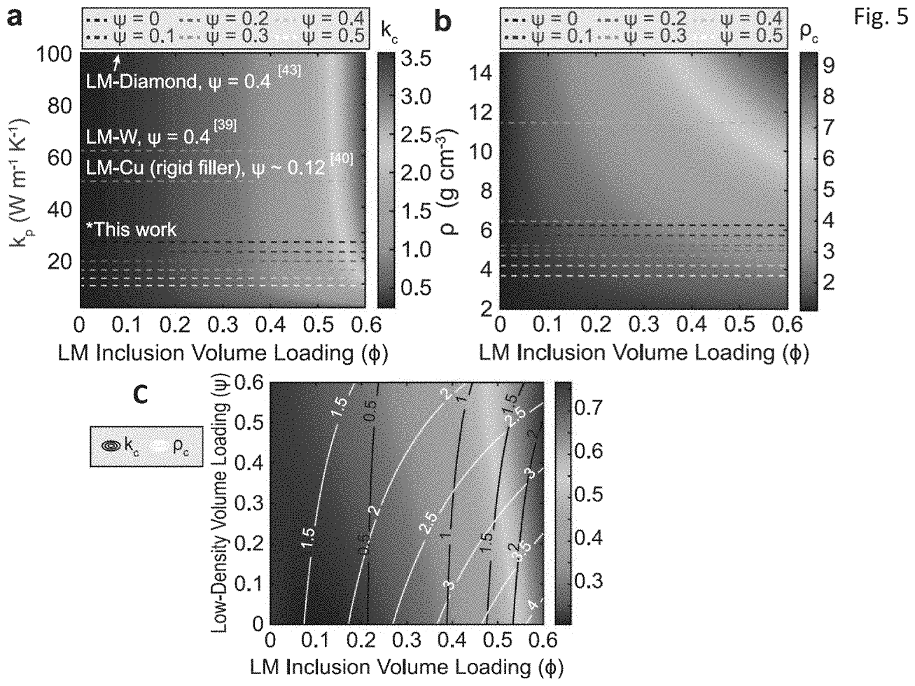

To quantitatively understand the influence of the filler properties on the bulk properties of the composite, we created a contour plot where the color map represents the predicted composite thermal conductivity using the Bruggeman EMT model (Equation 1 with L=⅓, kₘ=0.25 W m⁻¹ K⁻¹). The y-axis represents the filler thermal conductivity (kₚ) and the x-axis represents the filler volume loading ((p; FIG. 5a). Here we see that the composite thermal conductivity increases with increasing filler loading. However, for any given filler loading, only modest increases in composite thermal conductivity is observed with increasing filler thermal conductivity. As the filler thermal conductivity (kₚ) approaches the thermal conductivity of the elastomer, more significant changes are observed. Next, we create a contour plot where the color map represents the predicted composite density (ρ_{c}=ρₚ·φ+ρₘ(1−φ), ρₘ=1.12; FIG. 5b). The y-axis represents the particle filler density (ρₚ) and the x-axis represents the filler volume loading (φ). Here we see that the composite density increases with increasing filler density and loading. In summary, increasing the thermal conductivity of the LM particle filler has only a modest influence on the composite thermal conductivity, while decreasing the density has a more substantial effect.

The quantitative design maps of thermal conductivity and density as a function of filler properties demonstrate the advantage of a multiphase filler with a low-density phase. Metallic particles, such as copper, can significantly increase the thermal conductivity of the LM mixture with negligible changes in density (FIG. 5a,b; green dashed line). However, when copper particles are mixed with Ga-based LMs, intermetallic species of CuGa₂ form. These intermetallic species cause the LM mixture to solidify, even at small volume loadings ≈10%. LM hybrid mixtures with metallic particles that don't form intermetallic species, such as tungsten (LM-W), have been shown to enhance the thermal conductivity of Ga-based LMs, while maintaining liquid or paste-like consistency for volume loadings less than 50% (FIG. 5a,b; orange dashed line). However, when dispersed in elastomer, the LM-W mixture provides only a modest increase in the composite thermal conductivity (k_{LM-W}/k_{LM}≈109.5%) with a significant increase in composite density (μ_{LM-W}/ρ_{LM}≈170.6%), as compared to the LLME composite with pure LM and φ=50% filler loading. Particles with higher thermal conductivity and lower density, such as diamond, can not only enhance the thermal conductivity of Ga-based LMs but improve the material and functional properties of elastomer composites (FIG. 5a,b; red dashed line). LM-diamond hybrid mixtures result in a 13.3% increase in the composite thermal conductivity (k_{LM-D}/k_{LM}≈113.3%) and 17.5% decrease in composite density (ρ_{LM-D}/ρ_{LM}≈82.5%), as compared to the LLME composite with pure LM and φ=50% filler loading. However, diamond's high cost can be prohibitive. Alternatively, particles with lower density and negligible thermal conductivity, such as hollow glass microspheres, can be used to decrease the density of the LLME composite with modest decreases to the thermal conductivity. LM-glass microsphere hybrid mixtures result in a 20% decrease in the composite thermal conductivity (k_{LM-GM}/k_{LM} 80.5%) and 35% decrease in composite density (ρ_{LM-GM}/ρ_{LM}≈65.1%), as compared to the LLME composite with pure LM and φ=50% filler loading. Hybrid mixtures of LM with solid particles provide new opportunities to achieve desirable combinations of thermal, electrical, and mechanical properties. However, the solid particle must be carefully selected, while considering trade-offs between chemical and mechanical stability, functional properties, density, and stiffness of the filler. The quantitative design maps provide new insight into the relationship between LM filler and LM embedded elastomer composite properties and can be used as a tool for designing soft and elastically deformable materials with high thermal conductivity.

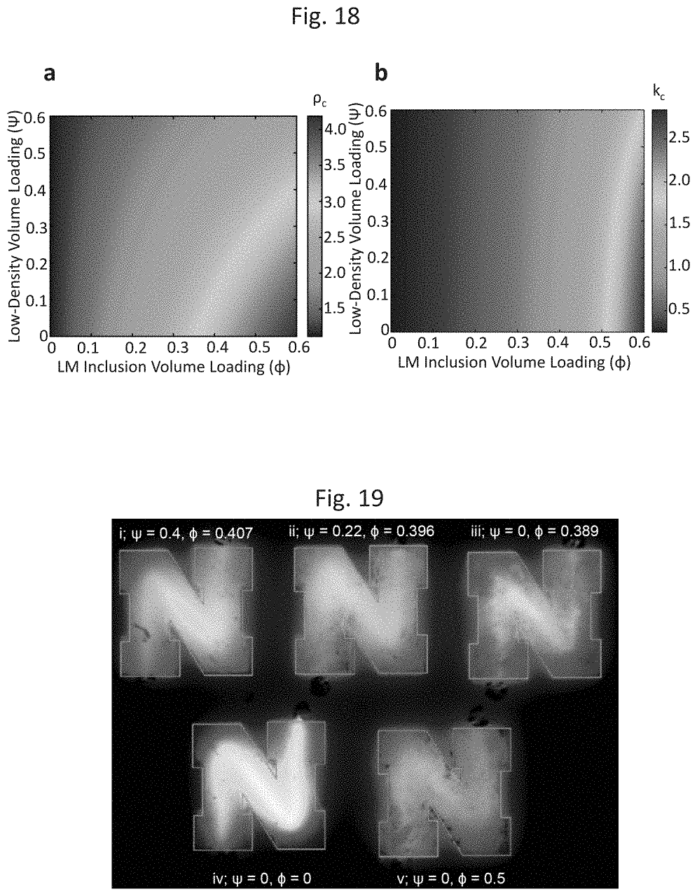

To quantitatively guide the rational selection of the LLME material composition and achieve the desired density and thermal conductivity, we created a contour plot where the color map represents the predicted composite thermal conductivity normalized by the density (FIG. 5c). The y-axis represents the volume loading of the low-density filler in the multiphase LM filler (ψ) and the x-axis represents the multiphase LM filler volume loading (φ). Contour lines indicating constant density (white) and constant thermal conductivity (black) are overlaid on the contour plot. By following a contour line, the density or thermal conductivity of the composite can be adjusted while maintaining the other material property. Contour plots of composite density and thermal conductivity can be found in FIG. 18. We note that the x-axis (ψ=0%) of the contour plot represents the pure LM elastomer composite. From the quantitative map, we observe two general trends to achieve the independent control of material properties: 1) To reduce the density of the composite without modifying the thermal conductivity, the volume loading of the low-density filler is increased with minimal changes to the loading of the multiphase LM; 2) To increase the thermal conductivity of the composite without modifying the density, both the volume loading of the low-density filler and multiphase LM are increased simultaneously.

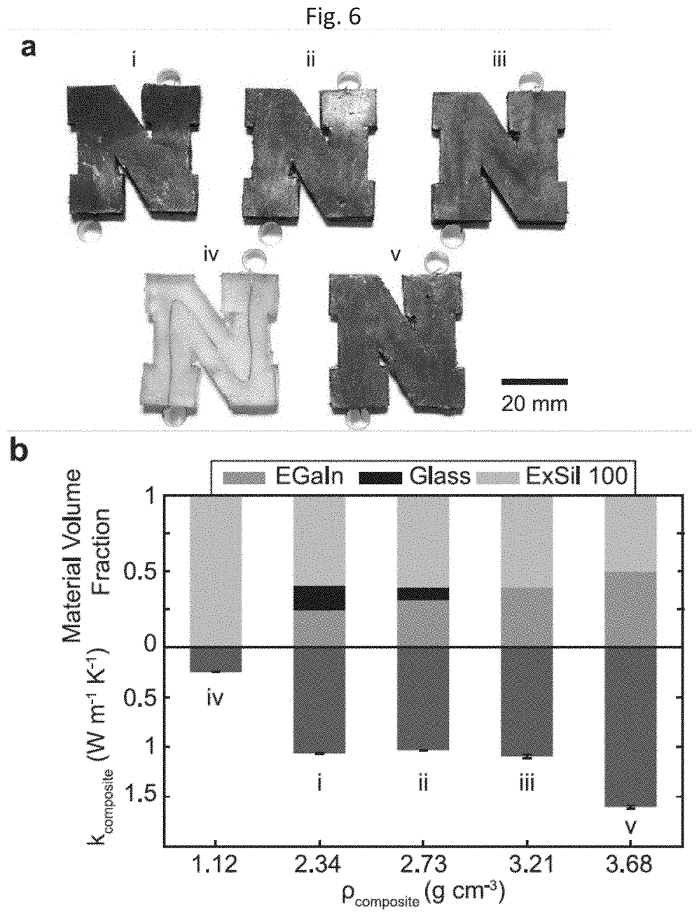

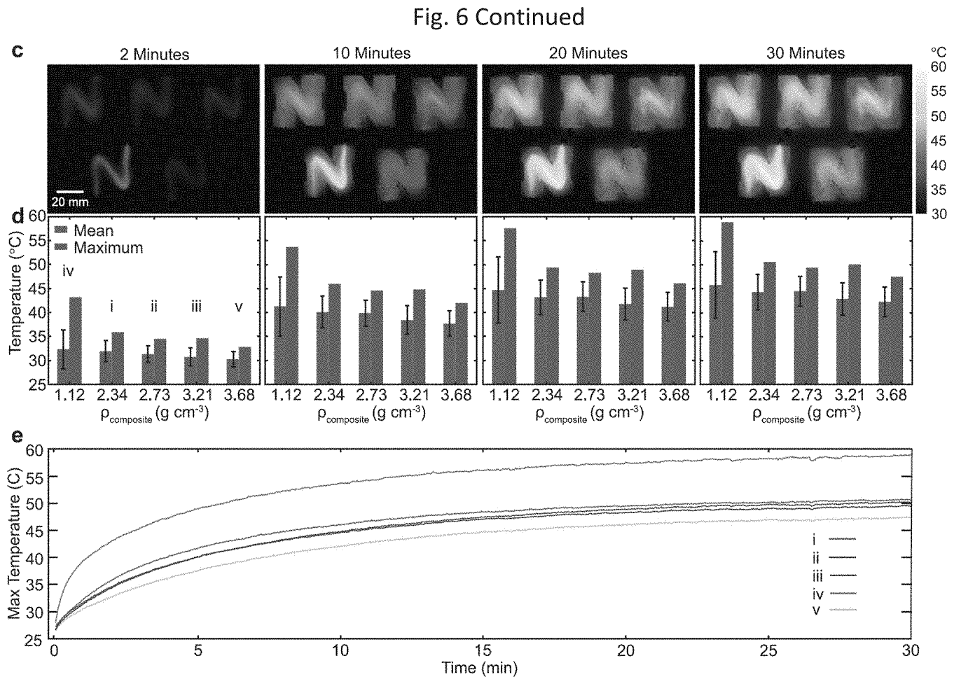

The ability to independently control the density and thermal conductivity in a predictable manner enables us to produce soft elastomer composites that can be utilized as a passive thermal management solution. Here, we demonstrate the LLME composite as a passive heat spreader to efficiently transfer and dissipate heat. The passive heat spreader could be utilized in emerging weight-sensitive and large-area applications such as wearable electronics, thermoregulatory garments, and thermally powered soft robotics. To evaluate the thermal management performance of the LLME composite as a passive heat spreader, a resistive heating element (Nichrome wire) was embedded in the composite before curing. The passive transferring of heat from the resistive heating element through the LLME heat spreader was visually captured using an infrared (IR) camera. Here, we fabricate three samples with varying material composition and density that have the same thermal conductivity of k_{c}=1 W m⁻¹ K⁻¹ (FIG. 6a). We start with the pure LM elastomer composite (iii; FIG. 6a) that has no glass microsphere loading ψ=0% with a LM volume loading of ψ=38.9% and a measured density of 3.21 g cm⁻³. Following the contour line of constant thermal conductivity (FIG. 6c), the density of the composite is reduced by primarily increasing the volume fraction of the low-density filler in the multiphase LM inclusions ii) ρ_{c}=2.73 g cm⁻³ (ψ=22% with φ=39.6%) and i) ρ_{c}=2.34 g cm⁻³=40% with φ=40.9%).

For both samples, to maintain a constant thermal conductivity, the volume fraction of the multiphase LM is slightly increased. The material composition in terms of volume fraction and the measured thermal conductivity (k_{c}) as a function of the density (ρ_{c}) is shown in FIG. 6b (top, bottom, respectively). Two additional samples (iv, φ=0% and v, φ=50% with ψ=0%) were included to illustrate the effect of material composition. The composite thermal conductivity (k_{c}) was measured using the two probe THW method and the density was measured gravimetrically using a density determination kit, as previously described. An IR camera was used to visually monitor the passive transferring of heat from the resistive heating element through the LLME heat spreader. All resistive heating elements were connected in series to a power supply to maintain a constant current. The entire LLME heat spreader was monitored to calculate the maximum temperature, mean temperature, and temperature deviation for each configuration of the LLME heat spreader, which can be found in the supporting information (FIG. 19). The samples were monitored for 30 min and IR snapshots at 2, 10, 20, and 30 min are shown in FIG. 6c. The mean and maximum temperature data recorded from the infrared camera at 2, 10, 20, and 30 min for each sample is plotted in FIG. 6d. The maximum temperature as a function of time is plotted in FIG. 6e. As expected, the pure elastomer iv) with the lowest thermal conductivity quickly heated up around the resistive heating element and had the highest maximum temperature (58.9° C.), highest mean temperature (45.8° C.), and largest temperature deviation (±7.0° C.) due to poor heat transfer. These results are expected as the pure elastomer sample with low thermal conductivity was unable to effectively transfer heat from the resistive heating element to the outer edge of the heat spreader. The three samples with the same thermal conductivity but different densities (i, ii iii) are shown to have a similar response. The difference in the maximum and mean temperature between samples was less than 1.5° C. with an average temperature deviation of ±3.4° C. These results indicate that the passive LLME heat spreader was able to efficiently transfer heat from the resistive heating element, even as the volume loading of the glass microspheres was increased to 40%. The pure LM elastomer sample v) with the highest thermal conductivity and density had the lowest maximum temperature (47.5° C.), mean temperature (42.3° C.), and temperature deviation (±3.1° C.). The maximum temperature, mean temperature, and temperature deviation for each sample are shown here.

Table 1 shows a comparison of the maximum temperature, mean temperature, and temperature deviation as a function of material composition at steady state. The resistive heating element has been turned on for 30 minutes. All temperature measurements are in Celsius.

TABLE 1

| | Material | | | | |
|---|---|---|---|---|---|
| Sample | Composition | | Maximum | Mean | Temperature |
| Number | ϕ | ψ | Temperature | Temperature | Deviation |
| i | 0.407 | 0.4 | 50.5 | 44.3 | 3.7 |
| ii | 0.396 | 0.22 | 49.4 | 44.3 | 3.1 |
| iii | .389 | 0 | 50.1 | 42.9 | 3.4 |
| iv | 0 | 0 | 58.9 | 45.8 | 7.0 |
| v | 0.50 | 0 | 47.5 | 42.3 | 3.1 |

This demonstration illustrates that by rationally selecting the material composition, multiphase composites with low-density fillers offer new opportunities to independently control the mechanical and functional properties of soft, multifunctional materials, which can be utilized as passive thermal management solutions for emerging weight-sensitive applications that demand mechanical compliance.

In summary, we have introduced a soft-matter composite with lightweight multiphase LM inclusions including a low-density phase suspended in a Ga-based LM to achieve independent control of the density and thermal conductivity. SEM imaging revealed that a majority of the hollow glass microspheres are suspended in the LM and are well distributed with minimal aggregation. We experimentally studied the viscosity and density of the multiphase LM as a function of glass microsphere loading. The multiphase LM exhibited a non-Newtonian, shear thinning behavior with increasing shear rate and transitioned from a liquid to thick paste as the volume loading of glass microspheres was increased (ψ≥30%). The addition of the low-density phase filler resulted in a significant decrease in the density (35%), modest decrease to the thermal conductivity (14%), and slight increase to the elastic modulus of the soft, elastomer composite as measured experimentally. Similar to composites with pure LM inclusions, the LLME composite exhibited a significant increase (k_{y}/kₒ≈4× at 400% strain) in composite thermal conductivity in the direction of stretch as the LM particles transitioned from spheres to needle-like microstructures along the stretching direction to create enhanced thermally conductive pathways. Based on the experimental validation of the density and thermal conductivity using the Bruggeman EMT model, we constructed quantitative design maps of the density and thermal conductivity of the composite as a function of the filler properties. These design maps provide new insight into the relationship between the LM filler and the LM embedded elastomer composite properties. To guide the rational selection of material composition, a quantitative design map can be constructed as a function of material composition. The ability to tailor material composition to control the density and thermal conductivity of the composite was experimentally demonstrated for passive thermal management. This new strategy for controlling functional properties, independent of density, will be broadly applicable and impactful for diverse weight-sensitive applications including aerospace thermal management, soft actuators, and wearable thermal management that demand mechanical compliance.

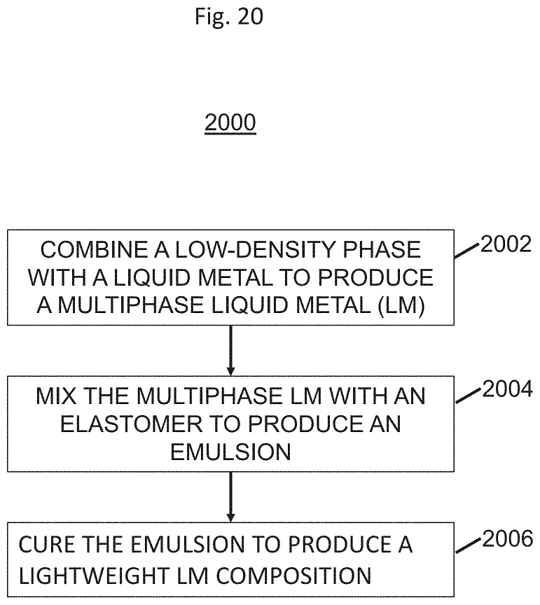

FIG. 20 shows an example 2000 of a process for producing a lightweight liquid metal composition in accordance with some embodiments of the disclosed subject matter. As shown in FIG. 20, at 2002, process 2000 can combine a low-density phase with a liquid metal to produce a multiphase liquid metal (LM), where the low-density phase may include a material having a density less than a density of the LM. At 2004, process 2000 can mix the multiphase LM with an elastomer to produce an emulsion. Finally, at 2006, process 2000 can cure the emulsion to produce a lightweight LM composition.

It should be understood that the above described steps of the process of FIG. 20 can be executed or performed in any order or sequence not limited to the order and sequence shown and described in the figures. Also, some of the above steps of the processes of FIG. 20 can be executed or performed substantially simultaneously where appropriate or in parallel to reduce latency and processing times.

### REFERENCES

Each of the following references are incorporated herein by reference in their entirety:
[1] R. W. Style, R. Tutika, J. Y. Kim, M. D. Bartlett, Adv. Funct. Mater. 2021, 31, 2005804.
[2] N. Kazem, T. Hellebrekers, C. Majidi, Adv. Mater. 2017, 29, 1605985.
[3] M. D. Dickey, Adv. Mater. 2017, 29, 1606425.
[4] M. D. Dickey, R. C. Chiechi, R. J. Larsen, E. A. Weiss, D. A. Weitz, G. M. Whitesides, Adv. Funct. Mater. 2008, 18, 1097.
[5] R. C. Chiechi, E. A. Weiss, M. D. Dickey, G. M. Whitesides, Angew. Chem., Int. Ed. 2008, 47, 142.
[6] T. Liu, P. Sen, C.-J. Kim, J. Microelectromech. Syst. 2011, 21, 443.
[7] L. Ren, X. Xu, Y. Du, K. Kalantar-Zadeh, S. X. Dou, Mater. Today 2020, 34, 92.
[8] S. H. Jeong, S. Chen, J. Huo, E. K. Gamstedt, J. Liu, S.-L. Zhang, Z.-B. Zhang, K. Hjort, Z. Wu, Sci. Rep. 2015, 5, 18257.
[9] M. D. Bartlett, N. Kazem, M. J. Powell-Palm, X. Huang, W. Sun, J. A. Malen, C. Majidi, Proc. Natl. Acad. Sci. USA 2017, 114, 2143.
[10] R. Tutika, S. H. Zhou, R. E. Napolitano, M. D. Bartlett, Adv. Funct. Mater. 2018, 28, 1804336.
[11] M. I. Ralphs, N. Kemme, P. B. Vartak, E. Joseph, S. Tipnis, S. Turnage, K. N. Solanki, R. Y. Wang, K. Rykaczewski, ACS Appl. Mater. Interfaces 2018, 10, 2083.
[12] M. H. Malakooti, N. Kazem, J. Yan, C. Pan, E. J. Markvicka, K. Matyjaszewski, C. Majidi, Adv. Funct. Mater. 2019, 29, 1906098.
[13] M. J. Ford, C. P. Ambulo, T. A. Kent, E. J. Markvicka, C. Pan, J. Malen, T. H. Ware, C. Majidi, Proc. Natl. Acad. Sci. USA 2019, 116, 21438.
[14] H. Bark, M. W. M. Tan, G. Thangavel, P. S. Lee, Adv. Energy Mater. 2021, 2101387.
[15] A. T. Hague, R. Tutika, R. L. Byrum, M. D. Bartlett, Adv. Funct. Mater. 2020, 30, 2000832.
[16] M. D. Bartlett, A. Fassler, N. Kazem, E. J. Markvicka, P. Mandal, C. Majidi, Adv. Mater. 2016, 28, 3726.
[17] A. Koh, J. Sietins, G. Slipher, R. Mrozek, J. Mater. Res. 2018, 33, 2443.
[18] R. Tutika, S. Kmiec, A. T. Hague, S. W. Martin, M. D. Bartlett, ACS Appl. Mater. Interfaces 2019, 11, 17873.
[19] C. Pan, E. J. Markvicka, M. H. Malakooti, J. Yan, L. Hu, K. Matyjaszewski, C. Majidi, Adv. Mater. 2019, 31, 1900663.
[20] C. Chiew, M. H. Malakooti, Compos. Sci. Technol. 2021, 208, 108752.
[21] J. Yang, D. Tang, J. Ao, T. Ghosh, T. V. Neumann, D. Zhang, E. Piskarev, T. Yu, V. K. Truong, K. Xie, Y.-C. Lai, Y. Li, M. D. Dickey, Adv. Funct. Mater. 2020, 30, 2002611.
[22] E. J. Markvicka, M. D. Bartlett, X. Huang, C. Majidi, Nat. Mater. 2018, 17, 618.
[23] E. J. Markvicka, R. Tutika, M. D. Bartlett, C. Majidi, Adv. Funct. Mater. 2019, 29, 1900160.
[24] A. Fassler, C. Majidi, Adv. Mater. 2015, 27, 1928.
[25] J. Wang, G. Cai, S. Li, D. Gao, J. Xiong, P. S. Lee, Adv. Mater. 2018, 30, 1706157.
[26] J. W. Boley, E. L. White, R. K. Kramer, Adv. Mater. 2015, 27, 2355.
[27] M. G. Mohammed, R. Kramer, Adv. Mater. 2017, 29, 1604965.
[28] Y. Lin, C. Cooper, M. Wang, J. J. Adams, J. Genzer, M. D. Dickey, Small 2015, 11, 6397.
[29] C. J. Thrasher, Z. J. Farrell, N. J. Morris, C. L. Willey, C. E. Tabor, Adv. Mater. 2019, 31, 1903864.
[30] S. Liu, M. C. Yuen, E. L. White, J. W. Boley, B. Deng, G. J. Cheng, R. Kramer-Bottiglio, ACS Appl. Mater. Interfaces 2018, 10, 28232.
[31] M. D. Bartlett, M. D. Dickey, C. Majidi, NPG Asia Mater. 2019, 11, 21.
[32] R. Tutika, A. T. Hague, M. D. Bartlett, Commun. Mater. 2021, 2, 64.
[33] A. T. Hague, R. Tutika, M. Gao, A. Martinez, J. Mills, J. A. Clement, J. Gao, M. Tabrizi, M. R. Shankar, Q. Pei, M. D. Bartlett, Multifunct. Mater. 2020, 3, 044001.
[34] S. Liu, D. S. Shah, R. Kramer-Bottiglio, Nat. Mater. 2021, 20, 851.
[35] T. V. Neumann, E. G. Facchine, B. Leonardo, S. Khan, M. D. Dickey, Soft Matter 2020, 16, 6608.
[36] Z. Ma, Q. Huang, Q. Xu, Q. Zhuang, X. Zhao, Y. Yang, H. Qiu, Z. Yang, C. Wang, Y. Chai, Z. Zheng, Nat. Mater. 2021, 20, 859.
[37] G. Bo, H. Yu, L. Ren, N. Cheng, H. Feng, X. Xu, S. X. Dou, H. Wang, Y. Du, ACS Appl. Nano Mater. 2021, 4, 550.
[38] H. Yu, W. Zhao, L. Ren, H. Wang, P. Guo, X. Yang, Q. Ye, D. Shchukin, Y. Du, S. Dou, H. Wang, Adv. Mater. 2020, 32, 2001571.
[39] F. Krisnadi, L. L. Nguyen, J. Ma, M. R. Kulkarni, N. Mathews, M. D. Dickey, Adv. Mater. 2020, 32, 2001642.
[40] W. Kong, Z. Wang, M. Wang, K. C. Manning, A. Uppal, M. D. Green, R. Y. Wang, K. Rykaczewski, Adv. Mater. 2019, 31, 1904309.
[41] J. Tang, X. Zhao, J. Li, R. Guo, Y. Zhou, J. Liu, ACS Appl. Mater. Interfaces 2017, 9, 35977.
[42] M. Ralphs, W. Kong, R. Y. Wang, K. Rykaczewski, Adv. Mater. Interfaces 2019, 6, 1801857.
[43] C. Zeng, J. Shen, J. Zhang, Diamond Relat. Mater. 2021, 112, 108230.
[44] S. Wei, Z. Yu, L. Zhou, J. Guo, J. Mater. Sci.: Mater. Electron. 2019, 30, 7194.
[45] W. Kong, Z. Wang, N. Casey, M. M. Korah, A. Uppal, M. D. Green, K. Rykaczewski, R. Y. Wang, Adv. Mater. Interfaces 2021, 8, 2100069.
[46] Z. Lin, H. Liu, Q. Li, H. Liu, S. Chu, Y. Yang, G. Chu, Appl. Phys. A 2018, 124, 368.
[47] S. Ki, J. Shim, S. Oh, E. Koh, D. Seo, S. Ryu, J. Kim, Y. Nam, Int. J. Heat Mass Transfer 2021, 170, 121012.
[48] X. Ge, J. Zhang, G. Zhang, W. Liang, J. Lu, J. Ge, ACS Appl. Nano Mater. 2020, 3, 3494.
[49] L. Han, L. Huiqiang, L. Zuoye, C. Sheng, Rare Metal Mater. Eng. 2018, 47, 2668.
[50] U. Daalkhaijav, O. D. Yirmibesoglu, S. Walker, Y. Mengüç, Adv. Mater. Technol. 2018, 3, 1700351.
[51] C. Wang, Y. Gong, B. V. Cunning, S. Lee, Q. Le, S. R. Joshi, O. Buyukcakir, H. Zhang, W. K. Seong, M. Huang, M. Wang, J. Lee, G.-H. Kim, R. S. Ruoff, Sci. Adv. 2021, 7, eabe3767.
[52] L. Ren, S. Sun, G. Casillas-Garcia, M. Nancarrow, G. Peleckis, M. Turdy, K. Du, X. Xu, W. Li, L. Jiang, S. X. Dou, Y. Du, Adv. Mater. 2018, 30, 1802595.
[53] F. Carle, K. Bai, J. Casara, K. Vanderlick, E. Brown, Phys. Rev. Fluids 2017, 2, 013301.
[54] I. A. de Castro, A. F. Chrimes, A. Zavabeti, K. J. Berean, B. J. Carey, J. Zhuang, Y. Du, S. X. Dou, K. Suzuki, R. A. Shanks, R. Nixon-Luke, G. Bryant, K. Khoshmanesh, K. Kalantar-Zadeh, T. Daeneke, Nano Lett. 2017, 17, 7831.
[55] L. Hu, H. Wang, X. Wang, X. Liu, J. Guo, J. Liu, ACS Appl. Mater. Interfaces 2019, 11, 8685.
[56] Y.-G. Park, H. Min, H. Kim, A. Zhexembekova, C. Y. Lee, J.-U. Park, Nano Lett. 2019, 19, 4866.
[57] L. Ren, N. Cheng, X. Man, D. Qi, Y. Liu, G. Xu, D. Cui, N. Liu, J. Zhong, G. Peleckis, X. Xu, S. X. Dou, Y. Du, Adv. Mater. 2021, 33, 2008024.
[58] H. Chang, P. Zhang, R. Guo, Y. Cui, Y. Hou, Z. Sun, W. Rao, ACS Appl. Mater. Interfaces 2020, 12, 14125.
[59] B. Yuan, C. Zhao, X. Sun, J. Liu, Adv. Funct. Mater. 2020, 30, 1910709.
[60] T. Lu, E. J. Markvicka, Y. Jin, C. Majidi, ACS Appl. Mater. Interfaces 2017, 9, 22055.
[61] R. Tutika, S. Kmiec, A. B. M. T. Hague, S. W. Martin, M. D. Bartlett, ACS Appl. Mater. Interfaces 2019, 11, 17873.
[62] J. N. Lee, C. Park, G. M. Whitesides, Anal. Chem. 2003, 75, 6544.
[63] Y. Nagasaka, A. Nagashima, J. Phys. E: Sci. Instrum. 1981, 14, 1435.
[64] M. D. Dickey, ACS Appl. Mater. Interfaces 2014, 6, 18369.
[65] D. A. G. Bruggeman, Ann. Phys. 1935, 416, 636.
[66] J. Liang, F. Li, Polym. Test. 2006, 25, 527.
[67] S. Vlassov, S. Oras, M. Timusk, V. Zadin, I. Sosnin, R. Löhmus, L. M. Dorogin, ChemRxiv 2020, https://doi.org/10.26434/chemrxiv.13342208.v1.
[68] S. Yu, M. Kaviany, J. Chem. Phys. 2014, 140, 064303.
[69] D. A. G. Bruggeman, Ann. Phys. 1935, 416, 636.
[70] O. Sigmund, “A 99 line topology optimization code written in matlab,” Structural and Multidisciplinary Optimization, vol. 21, no. 2, pp. 120-127, 2001.
[71] E. Andreassen, A. Clausen, M. Schevenels, B. S. Lazarov, and O. Sigmund, “Efficient topology optimization in MATLAB using 88 lines of code,” Struct. Multidiscip. Optim., vol. 43, no. 1, pp. 1-16, January 2011.
[72] Q. Li, G. P. Steven, O. M. Querin, and Y. M. Xie, “Shape and topology design for heat conduction by evolutionary structural optimization,” Int. J. Heat Mass Transf., vol. 42, no. 17, pp. 3361— 3371, September 1999.
[73] A. Gersborg-Hansen, M. P. Bendsøe, and O. Sigmund, “Topology optimization of heat conduction problems using the finite volume method,” Structural and Multidisciplinary Optimization, vol. 31, no. 4, pp. 251-259, 2006.
[74] J. Park, T. H. Nguyen, J. J. Shah, and A. Sutradhar, “Conceptual design of efficient heat conductors using multi-material topology optimization,” Engineering Optimization, vol. 51, no. 5, pp. 796-814, 2019.
[75] M. S. Hashemi, M. Safdari, and A. Sheidaei, “A supervised machine learning approach for accelerating the design of particulate composites: Application to thermal conductivity,” ArXiv, vol. abs/2010.00041, 2020.
[76] B. G. Compton and J. A. Lewis, “3d-printing of lightweight cellular composites,” Advanced materials, vol. 26, no. 34, pp. 5930-5935, 2014.
[77] H. L. Tekinalp, V. Kunc, G. M. Velez-Garcia, C. E. Duty, L. J. Love, A. K. Naskar, C. A. Blue, and S. Ozcan, “Highly oriented carbon fiber—polymer composites via additive manufacturing,” Composites Science and Technology, vol. 105, pp. 144-150, 2014.
[78] T. J. Ober, D. Foresti, and J. A. Lewis, “Active mixing of complex fluids at the microscale,” Proceedings of the National Academy of Sciences, vol. 112, no. 40, pp. 12 293-12 298, 2015.
[79] Y. Kim, H. Yuk, R. Zhao, S. A. Chester, and X. Zhao, “Printing ferromagnetic domains for untethered fast-transforming soft materials,” Nature, vol. 558, no. 7709, p. 274, 2018.
[80] M. A. Skylar-Scott, J. Mueller, C. W. Visser, and J. A. Lewis, “Voxelated soft matter via multi-material multinozzle 3d printing,” Nature, vol. 575, no. 7782, pp. 330-335, 2019.
[81] A. P. Shapiro and R. F. Probstein, “Random packings of spheres and fluidity limits of monodis-perse and bidisperse suspensions,” Physical review letters, vol. 68, no. 9, p. 1422, 1992.

### Examples

The following are non-limiting examples of embodiments of the disclosed procedures.

Multiphase Liquid Metal Fabrication:

Gallium and indium were purchased from Luciteria Science and combined at 75% Ga, 25% In by weight to produce EGaIn (LM). The multiphase LM was prepared by shear mixing and degassing 9-13 μm diameter hollow silica microspheres (440345, Sigma-Aldrich) with LM to form a colloidal suspension using a planetary mixer.

LLME Composite Fabrication:

The LLME composites were fabricated by dispersing multiphase LM microdroplets in a two-part polydimethylsiloxane (PDMS; ExSil 100; Gelest Inc.). The PDMS was first prepared by combining part A and part B at a 125:1 mass ratio and mixing/degassing in a planetary mixer (SpeedMixer DAC 400.2 VAC, FlackTek Inc). The PDMS was then shear mixed with the multiphase LM suspension at a high concentration (φ=50%). A planetary mixer was used for lower volume loadings ψ<30%. For higher glass microsphere volume loadings ψ≥30%, the two-part silicone elastomer was first thinned using hexane and combined at a 10:1, 6:1, and 5:1 mass ratio for ψ=30%, 40%, and 50%, respectively. The thinned PDMS was then mixed with the multiphase LM using a handheld immersion blender (Ultra-Stick, Mueller) and placed under vacuum for 3 h to evaporate the hexane before curing. The highly concentrated emulsion (φ=50%) could then be diluted to achieve the desired LM volume loading without influencing the LM droplet size. All emulsions were then cast into molds and cured at 120° C. for 4 h in a convection oven. For convenience, the different material composition criteria were

$$ψ = \frac{vol ( low density filler )}{vol ( low density filler + LM )} and$$

$$ϕ = \frac{vol ( multiphase LM )}{vol ( multiphase LM + elastomer )}$$

Thermal Characterization:

Samples were prepared as described in the Composite Fabrication Section and cast into acrylic molds with dimensions 40 mm×25 mm×3 mm. The surfaces of the samples were cleaned with IPA to remove any exposed LM. A THW probe including two perpendicular 25.4 μm diameter platinum wires (A-M systems) was placed between two samples and a 1 kg mass was placed on top of the samples to ensure good contact between the probe and samples. A source measure unit (Keithley 2461) with a four-wire configuration applied a 100 mA current to either the axial or transverse wire depending on the direction of thermal conductivity being measured. Three samples were tested for each glass volume loading and the thermal conductivity of each sample was measured five times with a 1 min cool-down period between each measurement. All measurements were conducted at room temperature.

For thermo-mechanical characterization, samples were prepared as described in the Composite Fabrication Section and cast into acrylic molds with dimensions 40 mm×60 mm×3 mm. The samples were glued (Sil-Poxy, Smooth-On) to 6-mm-thick acrylic grips and allowed to cure overnight. The samples were attached to two linear actuators to control the sample strain. The samples were stretched from 0% to 400% strain and thermal conductivity in axial and orthogonal directions was measured at 100% strain increments.

For thermo-mechanical characterization after cyclic loading, samples were prepared as described in the Composite Fabrication Section and cast into acrylic molds with dimensions 30 mm×60 mm×3 mm. The anisotropic thermal conductivity of each unstrained sample was first measured using the THW method. The samples were then strained to 200% and relaxed at a rate of 20 mm min⁻¹ using a materials testing machine (5966; Instron). The anisotropic thermal conductivity was then measured in the stress-free state. The loading rate was increased to 40 mm min⁻¹ after cycle 10.

Mechanical Characterization:

Samples were prepared in a dog bone geometry (Die C, ASTM D412A) and tested on a materials testing machine (5966; Instron) with a 100 N load cell at a loading rate of 10 mm min⁻¹, unless otherwise noted. Three tests were conducted for each glass volume loading. The mechanical strain of each sample was corrected using image analysis. A series of horizontal red lines were spray painted onto each sample in 10 mm intervals. The strain test was recorded with a high-definition camcorder (NXCAM; Sony) at 1 frame s⁻¹. The recording of each sample was then analyzed with a custom MATLAB image processing script. The gauge strain calculated from the custom script was plotted against the tensile stress data output from the Instron test.

The tensile elastic modulus was found via cyclic strain testing of the dog bone samples. Each sample was conditioned through three strain and relaxation cycles each at 50%, 100%, 150%, and 200% strain to account for the Mullins effect on the elastic modulus. The modulus was calculated from the slope of the linear region of the 200% stress-strain curve.

Density measurements of both the multiphase LM and lightweight LM composites were conducted using a density determination kit (80253384, Ohaus). Three samples of each volume loading were measured to determine the material density. The mass of each sample was initially measured in air. The sample was then placed in DI water and the mass of the sample was recorded. The temperature of the DI water was then recorded and the water density was determined via tables provided in the user manual of the density determination kit.

Viscosity Measurement:

The viscosity of the multiphase LM (ψ=0%, 10%, 20%, 30%, 40%, 50%) was measured for the shear rate range of 1-100 s⁻¹ using a rheometer (AR1500ex, TA Instruments) with an 8 mm-diameter parallel plate geometry at 22° C. The gap of the parallel plate was set to be 1 mm to include a sufficient number of glass microspheres in the sample under test. Before testing, the multiphase LM sample was stirred and then immediately loaded to fill the gap perfectly. The top plate of the geometry was slowly rotated to spread out the sample uniformly before measurement. For each volume loading, the measurement was conducted three times by using a fresh sample for each measurement (n=3).

SEM Imaging and EDX Analysis:

The microstructural and elemental characterizations were conducted using an FEI Helios NanoLab 660 equipped with an EDAX Octane Super EDX spectroscopy system. The multiphase LM specimens with ψ=20% and ψ=50% were manually fractured after being submerged in liquid nitrogen and immediately placed in the SEM. Images of the fractured surfaces were obtained at voltages of 5 and 10 kV for ψ=20% and ψ=50%, respectively, in back-scattered mode to reflect the atomic contrast and elucidate the glass microspheres embedded in the pits generated during the cryogenic fracture of the specimens. A lower voltage of 5 kV was used for the ψ=20% specimen to reduce the drifting during EDX mapping. EDX was used to generate the quantitative elemental maps for both ψ=20% and ψ=50% specimens to corroborate the presence of glass microspheres in the EGaIn matrix. The glass microspheres were distributed on double-sided carbon tape and imaged at 2 kV using secondary electrons. Surface imaging of LM with ψ=50% on double-sided carbon tape was performed at 2 kV using secondary electrons.

Heavy Liquid Demonstration:

For the visual density demonstration, the “N”-shaped samples were suspended in a heavy liquid (LVP-3; TC-Tungsten Compounds). The density of the heavy liquid (2.90 g cm⁻³) was adjusted by adding DI water to match the density of the sample with the intermediate density of p=2.73 g cm⁻³.

Thermal Imaging Demonstration:

Five samples were prepared as described in the Composite Fabrication Section and cast in an “N”-shaped acrylic mold with a suspended resistive heating element (26 gauge Nichrome wire). The final thickness of the sample was ≈4.5 mm. The resistive heating elements were wired in series and a constant current was applied using the Keithly 2461 source measure unit. The transient and steady-state thermal responses were measured using an infrared camera (FLIR A655sc). Data recorded by the camera was used to determine the temperature distribution across each sample with software from FLIR.

3D printing of the LM-polymer composite to control material composition:

To manufacture the materials designed by the optimization routines, a new manufacturing strategy will be created based on direct ink writing to deposit the uncured LM-polymer composite including the LM inclusions dispersed in a liquid prepolymer. To achieve control of the composition throughout the printing process an active mixer will be created for blending a stream of pure polymer with a stream of polymer loaded with the lightweight LM inclusions. The composition and microstructure of the printed filaments will be investigated as a function of volume loading, flow rate through the mixer, and impeller speed of the mixer. The experimental results will lead to new scaling relationships between the mixer dimensions and operating conditions that govern efficient mixing of liquid prepolymers with liquid inclusions.

3D printing of the LM-polymer composite to control inclusion orientation and aspect ratio:

In contrast to rigid particle fillers that have fixed shape and size, liquid phase inclusions have the unique potential to enable control of microstructure during 3D printing. Shear forces generated during the printing process will be used to cause changes in the shape of the inclusions that will align with the printing direction. Such control could be utilized to tailor the spatial microstructure of the composite throughout a manufactured part. Controlling inclusion orientation and aspect ratio could be important for manufacturing high performance composites with anisotropic properties.

Thus, while the invention has been described above in connection with particular embodiments and examples, the invention is not necessarily so limited, and that numerous other embodiments, examples, uses, modifications and departures from the embodiments, examples and uses are intended to be encompassed by the claims attached hereto.

What is claimed is:

1. A lightweight liquid metal composition, comprising:
a liquid metal inclusion;
a low-density phase comprising a plurality of particles; and
an elastic polymer.

2. The composition of claim 1, wherein the liquid metal inclusion comprises a metal having a melting point below 100° C.

3. The composition of claim 2, wherein the metal comprises gallium.

4. The composition of claim 1, wherein the low-density phase comprises a material having a density less than a density of the liquid metal inclusion.

5. The composition of claim 4, wherein the plurality of particles of the low-density phase comprises a plurality of microspheres.

6. The composition of claim 5, wherein the plurality of microspheres comprises a plurality of hollow glass microspheres.

7. The composition of claim 1, wherein the elastic polymer comprises silicone.

8. The composition of claim 1, comprising a plurality of ellipsoidal particles, wherein each of the ellipsoidal particles comprises a portion of the liquid metal inclusion, the low-density phase, and the elastic polymer.

9. The composition of claim 8, wherein each of the plurality of ellipsoidal particles has a diameter that is at least five times and no more than ten times a diameter of the plurality of particles of the low-density phase.

10. The composition of claim 1, wherein the composition comprises:
at least 20% and no more than 80% by volume of the liquid metal inclusion,
no more than 75% by volume of the low-density phase, and
a remaining balance by volume of the elastic polymer.

11. The composition of claim 1, wherein each of the plurality of particles includes an affinity-promoting layer on a surface thereof.

12. The composition of claim 11, wherein the affinity-promoting layer comprises a metal oxide.

13. A method of producing a lightweight liquid metal composition, comprising:
combining a low-density phase with a liquid metal to produce a multiphase liquid metal (LM),
the low-density phase comprising a material having a density less than a density of the LM;
mixing the multiphase LM with an elastomer to produce an emulsion; and
curing the emulsion to produce a lightweight LM composition.

14. The method of claim 13, wherein the low-density phase comprises a plurality of particles, and
wherein combining further comprises mechanically shear mixing the plurality of particles of the low-density phase with the LM.

15. The method of claim 14, wherein mechanically shear mixing further comprises mechanically shear mixing in an oxygenated environment to produce an affinity-promoting oxide layer on a surface of each of the plurality of particles of the low-density phase.

16. The method of claim 13, wherein curing the emulsion further comprises heating the emulsion to produce the lightweight LM composition.

17. The method of claim 13, wherein mixing the multiphase LM with an elastomer further comprises:
adjusting a viscosity of the elastomer using a solvent,
mixing the multiphase LM with the viscosity-adjusted elastomer, and
removing solvent from the emulsion prior to curing the emulsion.

18. The method of claim 13, wherein mixing the multiphase LM with an elastomer further comprises mixing the multiphase LM with an elastomer to produce an emulsion comprising a plurality of ellipsoidal particles, wherein each of the ellipsoidal particles comprises a portion of the liquid metal, the low-density phase, and the elastomer.

19. The method of claim 13, wherein curing the emulsion to produce a lightweight LM composition comprises producing a lightweight LM composition comprising:
at least 50% and no more than 80% by volume of the liquid metal inclusion,
no more than 75% by volume of the low-density phase, and
a remaining balance by volume of the elastic polymer.

20. The method of claim 13, wherein the elastomer comprises at least one of a thermosetting plastic, a solution processable polymer, a UV curable polymer, or a high consistency rubber, and
wherein curing the emulsion to produce a lightweight LM composition comprises:
curing the emulsion using at least one of applying heat, removing solvent, applying compression, or UV crosslinking.

21. The method of claim 13, wherein combining a low-density phase with a liquid metal to produce a multiphase LM comprises:
combining the low-density phase with the liquid metal by forming LM droplets using at least one of sonication or microfluidic techniques, and
introducing the LM droplets into the elastomer.
